(19) United States
(12) Patent Application Publication
(10) Pub. No.: US 2018/0373820 A1
(43) Pub. Date: Dec. 27, 2018

(54) Methods and Systems for Constructing and Analyzing Component-Based Models of Engineering Systems Having Linear and Nonlinear Regions

(71) Applicant: Akselos S.A., Lausanne (CH)

(72) Inventors: David Knezevic, Boston, MA (US); Loi Nguyen, Ho Chi Minh City (VN); Phuong Huynh, Ho Chi Minh City (VN)

(21) Appl. No.: 15/632,719

(22) Filed: Jun. 26, 2017

(51) Int. Cl. G06F 17/50; G06F 7/64

(52) U.S. Cl. CPC G06F 17/5009; G06F 2217/16; G06F 7/64

(57) ABSTRACT

In one aspect, a method for modeling and analyzing a physical system comprising a plurality of components includes constructing, by a computing device, a model of the plurality of components. The computing device determines that the at least one component in the plurality of components represents a region for which at least a first portion of an associated partial differential equation is linear. The computing device accesses one of a plurality of datasets, the accessed dataset comprising a representation of the first portion of the partial differential equation. The computing device determines that a subset of the plurality of components encapsulates a region for which a second portion of the associated partial differential equation is non-linear. The computing device generates a combined output based on the partial differential equation combining the first portion and the second portion.

### BACKGROUND

The disclosure relates to modeling and analyzing a physical system comprising a plurality of components. More particularly, the methods and systems described herein relate to functionality for constructing and analyzing component-based models of engineering systems having both linear and nonlinear regions.

To evaluate a proposed solution to a complex engineering problem, an engineer typically uses a Finite Element Analysis (FEA) software tool to construct a mathematical model of the proposed solution and to run FEA simulations based on the mathematical model. For instance, when designing a bridge, a structural engineer can use an FEA tool to construct a model of a proposed design and to run simulations to determine whether any stress “hot spots” exist under various loading conditions.

FEA refers generally to a class of numerical analysis techniques for approximating solutions of partial differential equations. These techniques attempt to break down a complex physical system into simpler subsystems that are analyzed locally. For instance, in the example of the proposed bridge design, a mathematical domain representing the structure of the bridge can be divided into a set of disjoint subdomains each representing a portion of the structure. An unknown function of interest (e.g., displacement or stress) can then be approximated locally over each subdomain.

However, conventional FEA tools typically require users to go through extensive training to learn how to construct and analyze three-dimensional (3D) models. Even with adequate training, the model construction process tends to be complex and time-consuming and may require special, expensive equipment. For instance, while some conventional FEA tools allow users to construct 3D models and perform full-scale simulations, such simulations are computationally intensive and require powerful hardware infrastructure. Typically, to simulate a real-world problem such as a design of a bridge, each simulation run that corresponds to a particular set of loading conditions can take an hour or more to complete. Even with supercomputers, which are costly to acquire and maintain, engineers often need to wait more than a day to obtain simulation results on all loading conditions of interest. In many industrial contexts, for example, large structures which perforce exhibit a wide range of scales, even a single FEA solution may be prohibitively expensive. As a result, engineers are discouraged from verifying their designs using full-scale 3D simulations. Instead, engineers often rely on more limited modeling techniques, such as those based on one-dimensional (1D) “stick” models. Such techniques may lead to oversimplification of complex physical systems and hence may be less effective in uncovering design flaws. Therefore, a need exists for a simulation tool that allows users to construct and analyze 3D models in a simple and intuitive manner and that can deliver results with less wait time, or even in real time, and without expensive hardware.

Furthermore, conventional FEA tools do not provide efficient mechanisms for fine tuning system designs. For example, whenever a user modifies any aspect of a design, a conventional FEA tool re-computes a full FEA solution on the entire physical system. As a result, conventional FEA tools are unable to deliver updated simulation results in real time, even for minor modifications. Therefore, a need exists for a simulation tool that provides convenient mechanisms for modifying system designs and efficiently computes updated simulation results.

Additionally, conventional FEA tools offer few opportunities for reusing existing work. A user typically constructs a new FEA model for each new physical system to be analyzed, and a full FEA solution is computed based on the new model, even if the new physical system shares similar components with physical systems previously analyzed. Therefore, a need exists for a simulation tool that provides convenient mechanisms for managing and reusing previously computed data, which may significantly shorten the amount of time needed to build a computational model and perform a simulation.

Although there are approaches that provide solutions for modeling portions of models that benefit from, or require, linear analyses, such approaches do not typically provide functionality for modeling non-linear regions.

### BRIEF SUMMARY

In one aspect, a method for modeling and analyzing a physical system comprising a plurality of components includes constructing, by a computing device, a model of the plurality of components, wherein the model is based at least in part on at least one parameter relating to a physical characteristic of at least one component. The method includes determining, by the computing device, that the at least one component in the plurality of components represents a region for which at least a first portion of an associated partial differential equation is linear. The method includes accessing, by the computing device, based at least in part on a component type of the at least one component, a dataset from a plurality of datasets, the dataset comprising a representation of the first portion of the partial differential equation, wherein: the component is an N-dimensional component, N being at least 2, the component comprises an N-dimensional interior region and an (N−1)-dimensional port, the dataset comprises a plurality of basis functions for a reduced basis space associated with an interface function for the (N−1)-dimensional port, and a solution of the first portion of the partial differential equation represented by the accessed dataset depends on at least two independent spatial variables. The method includes determining, by the computing device, that a subset of the plurality of components encapsulates a region for which a second portion of the associated partial differential equation is non-linear. The method includes generates, by computing device, a combined output based on the partial differential equation combining the first portion and the second portion, wherein a finite element analysis is used in conjunction with the second portion of the associated partial differential equation, the combined output including at least one output value of the at least one component based on at least one input value and wherein the at least one input value is indicative of at least one physical condition under which the physical system is to be evaluated, and the combined output is indicative of a behavior of the physical system under the at least one physical condition.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a block diagram depicting an embodiment of a system for constructing and analyzing component-based models of engineering systems;

FIG. 2A shows an illustrative process that may be performed by a simulation tool to assist a user in constructing and analyzing a component-based model for a physical system, in accordance with some embodiments;

FIG. 2B shows an illustrative process that may be performed by a simulation tool to process one or more modifications to a component-based model of a physical system;

FIGS. 3A-J illustrate various features of a simulation tool, such as features for connecting and cloning components, via an example of a series of user interactions relating to an analysis of an arch structure;

FIGS. 4A-C illustrate various features of a simulation tool for modifying components;

FIGS. 5A-5B illustrate an example in which a simulation tool is used to analyze a potential system failure;

FIG. 6 is a flow diagram depicting one embodiment of a method for preparing an evaluation dataset for a reference component;

FIG. 7 is a flow diagram depicting one embodiment of a method for instantiating component models and evaluating a system model;

FIG. 8 is a flow diagram depicting an embodiment of a method for modeling and analyzing a physical system comprising a plurality of components including both linear and non-linear regions; and

FIGS. 9A-9B are block diagrams depicting embodiments of computers useful in connection with the methods and systems described herein;

### DETAILED DESCRIPTION

The methods and systems described herein provide functionality for modeling and analyzing a physical system comprising a plurality of components, which may include analyses of both linear and non-linear regions.

In accordance with some embodiments, an improved simulation tool is provided that allows a user to construct a model for a physical system in a “bottom-up” fashion, by creating models for components in the physical system and specifying how the components are interconnected. For instance, each component in the physical system may have one or more ports for connecting to one or more other components, so that the user may specify a connection between a first component and a second component by simply selecting a first port of the first component and a second port of the second component and indicating that the first and second ports are to be connected. The systems and methods described herein further provide functionality for modeling the components even when they include both linear and non-linear regions.

In one embodiment, the system provides parametrizable components. For example, in one implementation, a library of reference components is provided, where each reference component may conceptually represent a component type, such as a component with one or more parameters unspecified. In such an embodiment, a user may create a component model simply by selecting a reference component from the library of reference components and then specifying one or more parameters to be used to instantiate the selected reference component.

In some implementations, a static condensation procedure may be used to eliminate one or more degrees of freedom internal to at least one component in the physical system, and a reduced basis (RB) approximation technique may be applied to reduce the computational complexity associated with the static condensation procedure. For example, rather than computing an exact solution for a so-called “bubble function” as done in a conventional static condensation procedure, an RB approximation of the bubble function may be computed, which may lead to significant computational savings.

The systems and methods describe functionality for decomposing an RB computation into two steps, construction and evaluation, such that the construction step may be computationally expensive but may result in readily reusable data, while the evaluation step may be computationally inexpensive. For example, in an embodiment with parametrizable components, a construction step may produce data corresponding to a reference component (which may, mathematically, correspond to a family of components that differ only in one or more parameters), and an evaluation step may use the data produced by the construction step to construct and analyze a component model corresponding to an instance of the reference component (e.g., with specified parameter values). As a more specific example, the construction step may involve solving one or more instances of at least one partial differential equation or a portion of a partial differential equation, where each instance may correspond to a different set of one or more parameters for the partial differential equation. The data thus generated may be used during the evaluation step to solve any new instance of the partial different equation corresponding to any set of parameters drawn from selected parameter ranges. In this manner, the cost incurred during the construction step for a reference component may be amortized over multiple instantiations of the reference component. Furthermore, in some embodiments, the construction step may be performed offline (e.g., before actual parameters are determined for a specific problem), so that only the relatively inexpensive evaluation step is performed online.

In accordance with further embodiments, an improved simulation tool is provided that allows a user to modify one or more aspects of a physical system and obtain updated simulation results in real time. For instance, user interface functions may be provided for the user to perform various modifications, including, but not limited to, modifying one or more parameters of a component, adding a component (e.g., by cloning an existing component), removing a component, disconnecting previously connected components, moving a component from one part of the physical system to another part of the physical system, and rotating a component. In response to such changes requested by the user, the simulation tool may be able to quickly deliver updated simulation results by leveraging previously computed data. For example, in some implementations, the simulation tool may update certain computations relating to components whose parameters and/or connections are changed, but may reuse previously computed data for components that are not directly affected by the changes.

In accordance with further embodiments, an improved simulation tool may perform one or more consistency checks to determine whether changes requested by a user are compatible with other aspects of a physical system. The simulation tool may alert the user if any incompatibility is detected. Additionally, or alternatively, the simulation tool may propose further changes to the physical system to remove one or more incompatibilities introduced by the user-requested changes.

In accordance with further embodiments, an improved simulation tool is provided that automatically computes an error associated with a simulation result. In some implementations, an error may be a rigorously computed error bound, such as a maximum possible difference between the simulation result and a result that would have been obtained had a full FEA solution been computed. For example, in an embodiment in which RB approximations are computed for bubble functions, a “local” error bound may be computed for each bubble function, where the local error bound indicates a difference between a reduced order model computed for the bubble function and a corresponding full FEA solution. Such local error bounds may then be combined to obtain an overall error bound for an entire physical system or a portion thereof. In other implementations, an error may be an error estimate that can be computed in less time compared to a rigorous error bound. In yet some other implementations, a user may choose which type of error (e.g., rigorous error bound or error estimate) is to be computed by the simulation tool. Following below are more detailed descriptions of various concepts related to, and embodiments of, inventive systems, methods, and apparatus for constructing and analyzing component-based models of engineering systems.

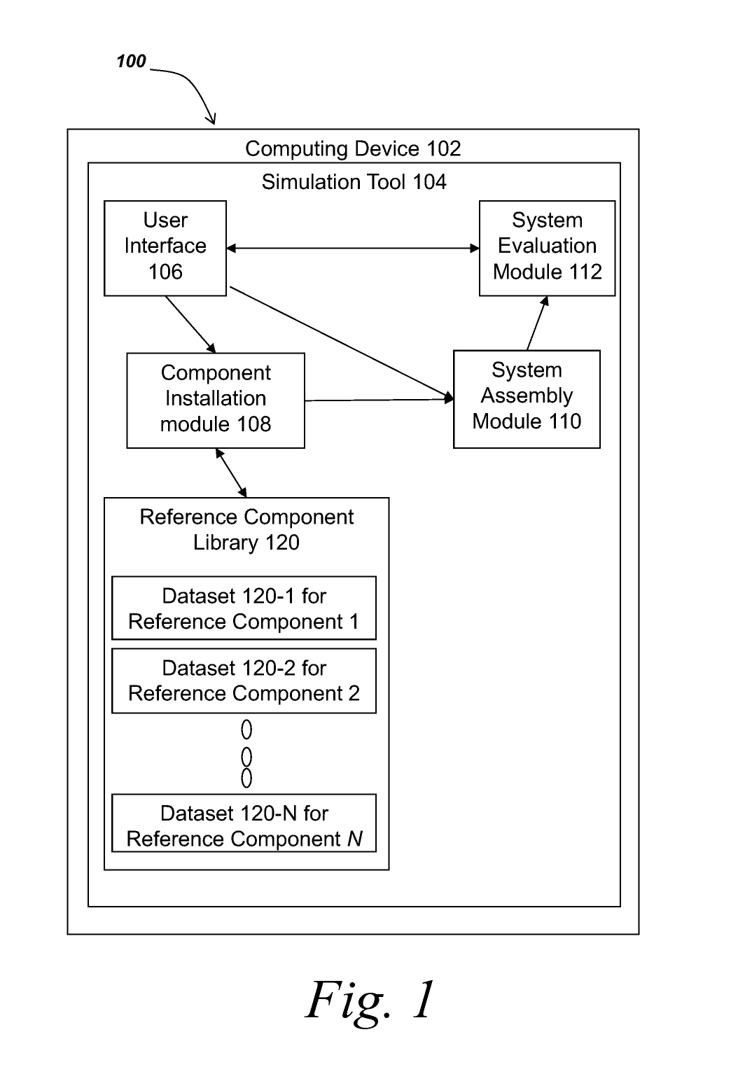

Referring now to FIG. 1, a block diagram depicts an embodiment of a system 100 including a computing device 102 executing a simulation tool 104 for constructing and analyzing component-based models of engineering systems. The simulation tool 104 may be used to model and analyze a variety of different engineering problems, including, but not limited to, problems relating to solid mechanics, fluid mechanics, heat transfer, and acoustics. For instance, in some embodiments, the simulation tool 104 may be adapted to generate and solve systems of partial differential equations representing different types of physical problems, including, but not limited to, equilibrium problems, eigenproblems, and time-dependent problems. In further embodiments, the simulation tool 104 may be adapted to generate and solve a system of partial differential equations representing a combination problem, for example, a buckling problem, which may be a combination of an eigenproblem and an equilibrium problem.

In one embodiment, the components depicted in FIG. 1 are implemented in software. In another embodiment, the components depicted in FIG. 1 are implemented in hardware. In one embodiment, the components depicted in FIG. 1 execute on the machine 100. In another embodiment, the functionality of the components depicted in FIG. 1 are distributed across a plurality of machines 106a-n (not shown).

In the example shown in FIG. 1, the illustrative simulation tool 104 includes a user interface 106 through which a user may interact with the simulation tool 104. For instance, the user interface 106 may allow the user to construct a model for a physical system by specifying one or more aspects of the physical system, such as geometry, material, and/or any other suitable physical characteristics. Once such a model is constructed, the user may, again via the user interface 106, direct the simulation tool 104 to perform a simulation based on the model to predict how the physical system may behave under one or more selected conditions. Results of the simulation may be delivered to the user via the user interface 106 in any suitable manner, such as by visually rendering one or more output values of the simulation.

In some embodiments, the simulation tool 104 may allow the user to construct a model in a “bottom-up” fashion, by creating models for components in the physical system and specifying how the components are interconnected. For instance, the simulation tool 104 may allow the user to create a model for a component by browsing through a reference component library 120. (As discussed above, a reference component may conceptually represent a component with one or more parameters unspecified, or a component type.) The user may select, from the reference component library 120, a reference component having one or more desired characteristics, such as geometry, material, and/or any other suitable physical characteristics, and specify one or more parameters to be used by the simulation tool 104 to instantiate the selected reference component. Furthermore, the simulation tool 104 may allow the user to specify how the component is to be “docked” within the physical system, for example, by specifying one or more ports of the component and one or more corresponding ports of the physical system and indicating that the component is to be connected to the physical system at the specified ports.

In the example shown in FIG. 1, the simulation tool 104 includes a component instantiation module 108 adapted to use the component parameters specified by the user instantiate the reference component selected by the user. For instance, the component instantiation module 108 may be adapted to access a reference component library 120 that stores a plurality of datasets (e.g., datasets 120-1, 120-2, . . . 120-N, as shown in FIG. 1) corresponding respectively to a plurality of reference components. The component instantiation module 108 may access a dataset corresponding to the reference component selected by the user, and may use the component parameters specified by the user and the accessed dataset to create a component model. For example, in some embodiments, the component instantiation module 108 may use the component parameters specified by the user and the dataset accessed from the library 120 to derive one or more partial differential equations that represent the component. As a more specific example, the component instantiation module 108 may use the component parameters specified by the user and the dataset accessed from the library 120 to compute a so-called “local stiffness matrix” and a so-called “local load vector” that represent the component.

In various embodiments, pre-computed reference component datasets may be made available to users via different channels. For example, an educational institution, an engineering firm, an equipment manufacturer, or some other suitable entity may develop and maintain a library of pre-computed reference component datasets for internal use. As another example, a group of entities may enter into an agreement to jointly develop and maintain a shared library of pre-computed reference component datasets. As yet another example, a component manufacturer may make pre-computed reference component datasets available to component purchasers, either with the purchase of corresponding components, or as an additional service. As yet another example, a library of pre-computed reference component datasets may he maintained by a private or governmental entity, where public access may be allowed either at no charge or under some suitable billing arrangement. For instance, a user may pay a fee to subscribe to the library. Additionally, or alternatively, a user may pay a fee for each dataset accessed from the library. The fee may vary depending on a number of factors, such as a subscription package paid for by the user, whether the accessed dataset belongs to a pool of premium content, and/or whether a contributor of the dataset receives compensation for allowing access to the dataset. Other ways of developing, maintaining, and/or distributing pre-computed reference component datasets may also be possible, as aspects of the present disclosure are not so limited.

Returning to the example shown in FIG. 1, the simulation tool 104 further includes a system assembly module 110 adapted to construct a model for the overall physical system based on component models created by the component instantiation module 108 and information provided by the user regarding how the components are to be connected. For instance, in an embodiment in which the components are connected at ports specified by the user, the component models created by the component instantiation module 108 may contain information relating to the ports, and the system assembly module 110 may use the information relating to the ports to combine the component models into a system model. For example, in some embodiments, the system model may include one or more partial differential equations, or portions of partial differential equations, representing the overall physical system, and the system assembly module 110 may derive the partial differential equations representing the overall physical system using partial differential equations representing individual components. As a more specific example, the system assembly module 110 may use local stiffness matrices and local load vectors associated with the components to compute a global stiffness matrix and a global load vector for the overall physical system.

In the example shown in FIG. 1, the simulation tool 104 further includes a system evaluation module 112 adapted to compute one or more output values of interest based on one or more input values provided by the user. Such input values may represent loading and/or boundary conditions for the physical system being analyzed. In some embodiments, the physical system comprising a plurality of components includes a component having a port that is not connected to any other component in the physical system; the composite model of the physical system is constructed based at least in part on one or more boundary conditions for the third port. For instance, in an example in which the physical system is a bridge, the user may specify a location at which a load is to be applied to the bridge and a size of the load, which may be used by the system evaluation module 112 as loading conditions. The user may further specify that the bottom of each pillar of the bridge is to have zero displacement, which may be used by the system evaluation module 112 as boundary conditions. The system evaluation module 112 may then apply such loading and/or boundary conditions to the system model constructed by the system assembly module 110 to compute one or more output values of interest, such as displacement and/or stress at various parts of the bridge. Such output values may be delivered to the user via the user interface 106 in any suitable manner, for example, by visually displaying one or more graphs, charts, and/or other suitable representations of the output values. Additionally, or alternatively, the output values may be stored in some suitable storage device for future access. In some embodiments, constructing the model for evaluation includes using information relating to a first port to define a relationship between a model of the first component and a second model of a second component. In other embodiments, the simulation tool 104 provides functionality for verifying whether a consistency criterion is satisfied in connecting the first port of the first component to the second port of the second component. In one of these embodiments, the simulation tool 104 provides functionality for determining whether a consistency criterion is violated due to modifying the first aspect of the physical system as requested; if it is determined that a consistency criterion is violated due to modifying the first aspect of the physical system as requested, the simulation tool 104 provides functionality for modifying at least one second aspect of the physical system so that the consistency criterion is no longer violated.

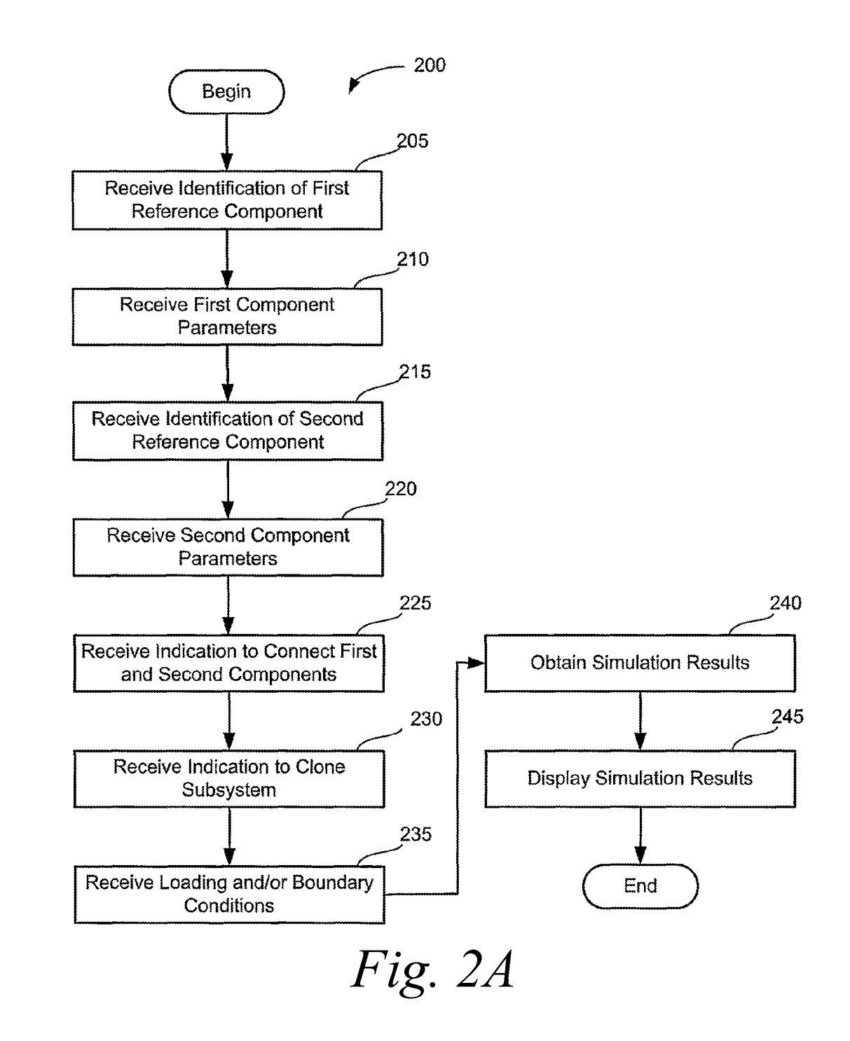

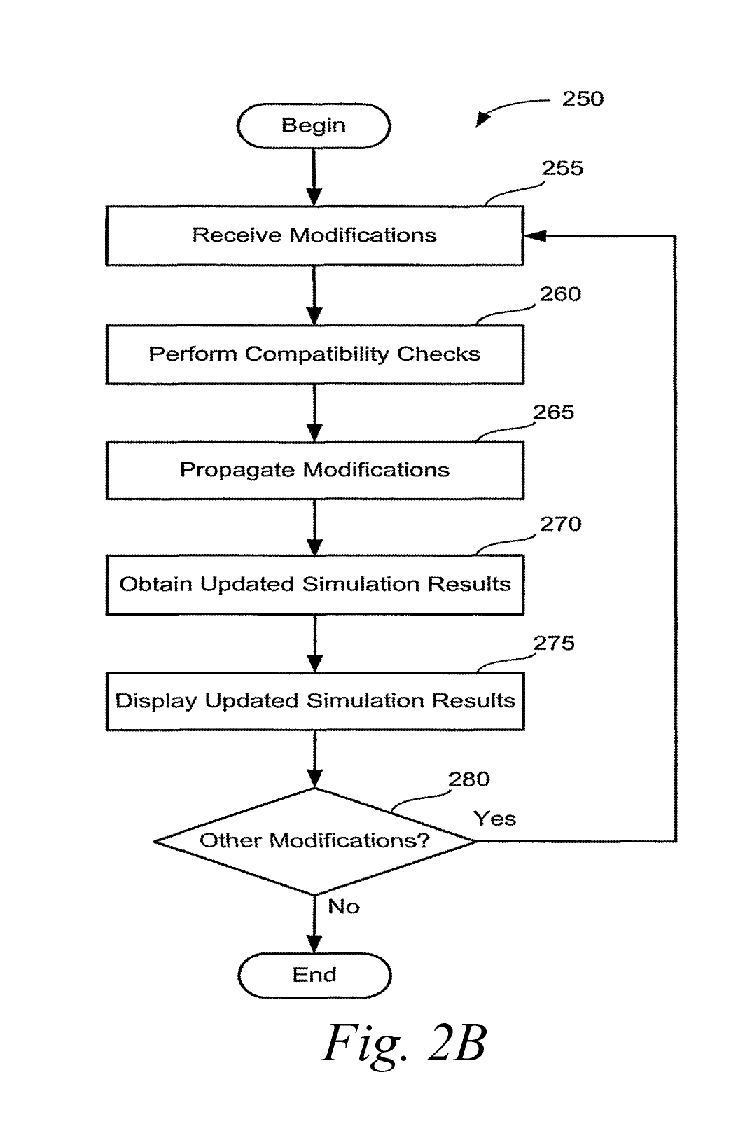

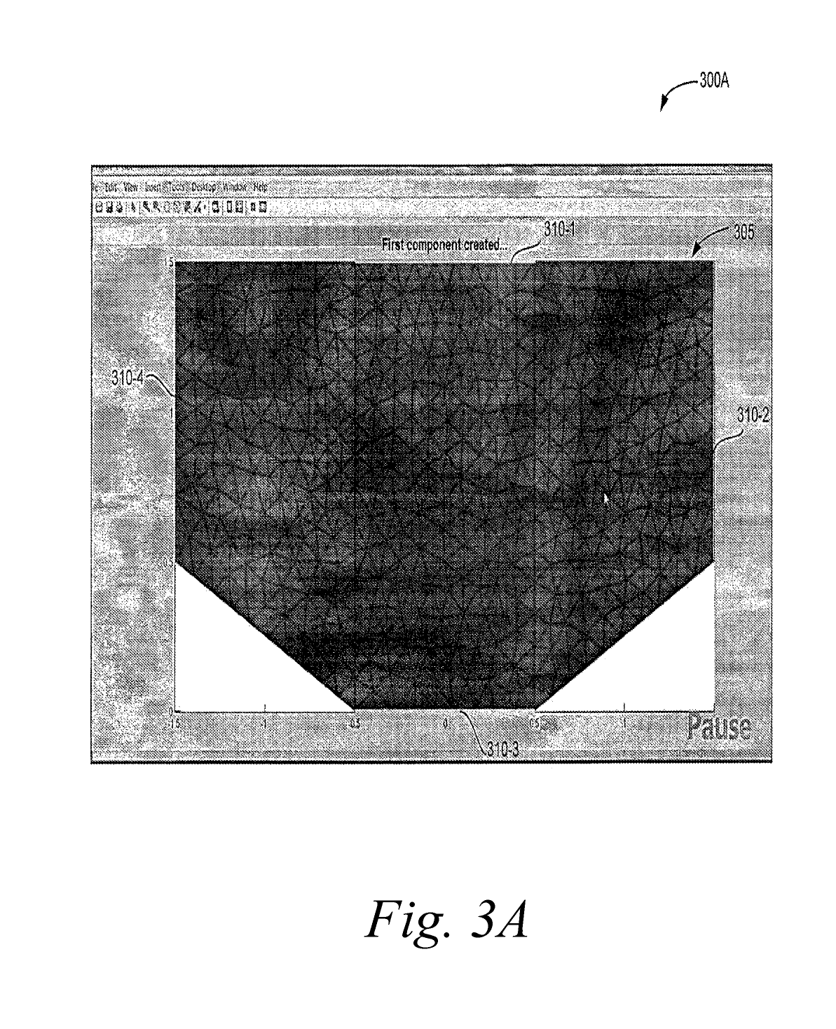

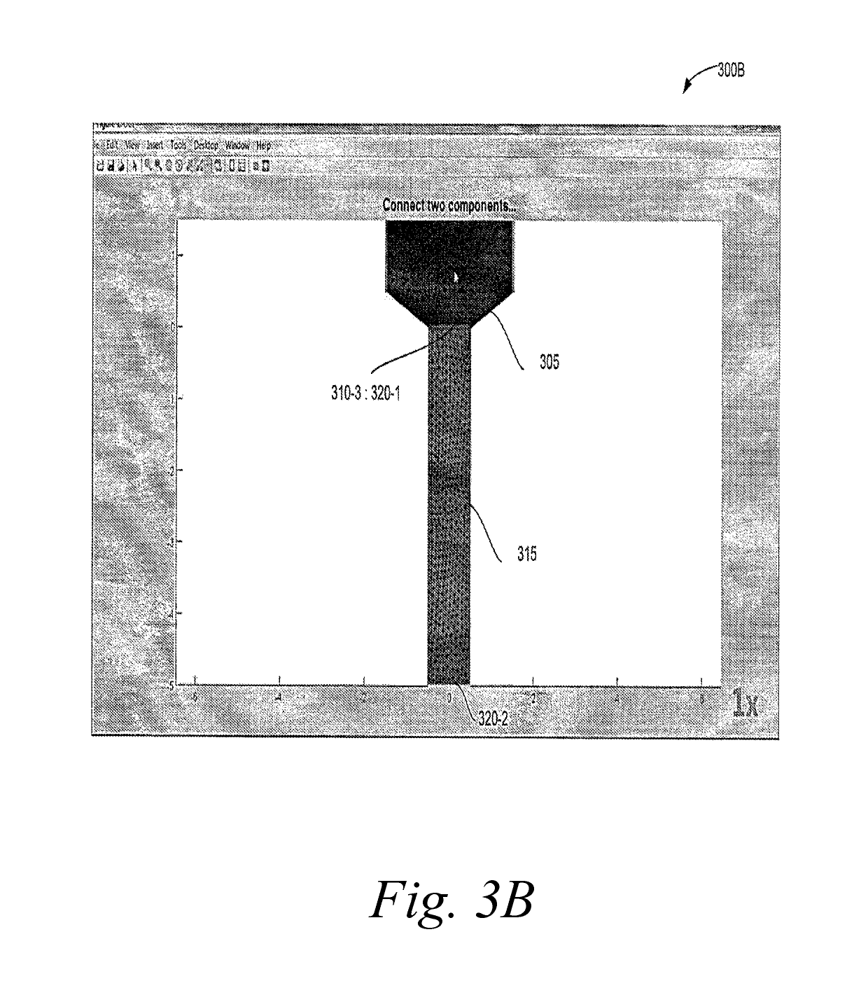

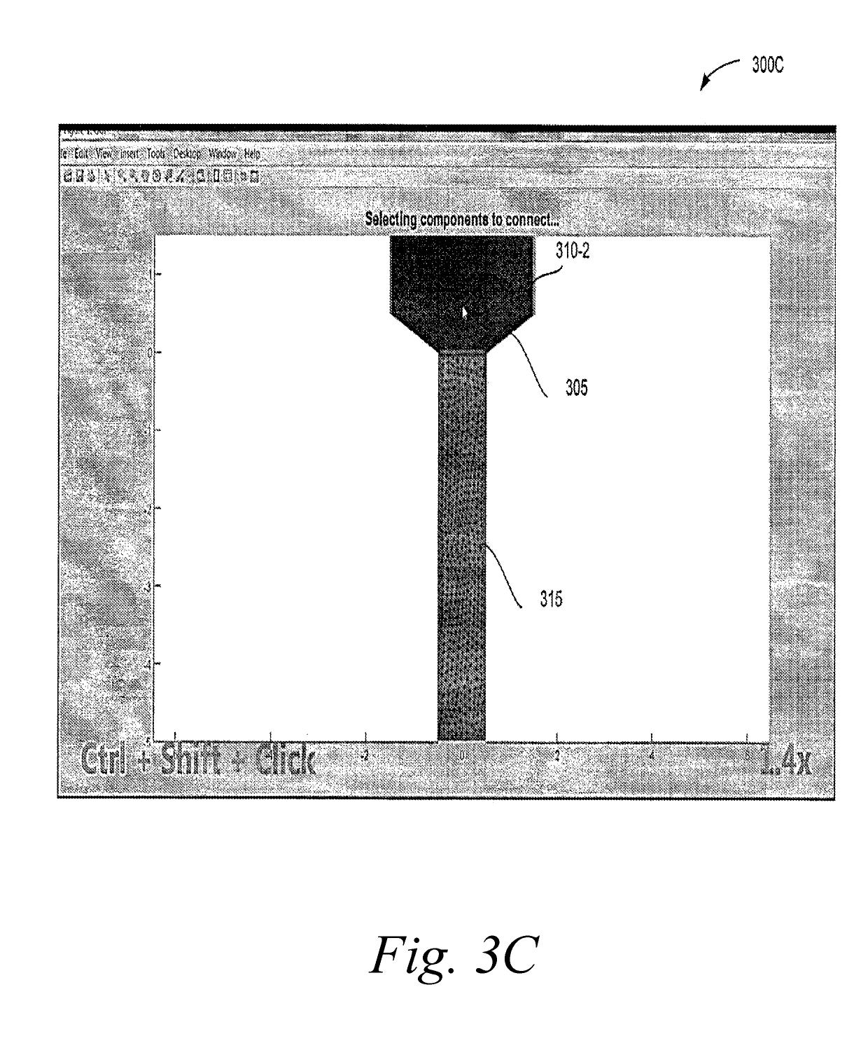

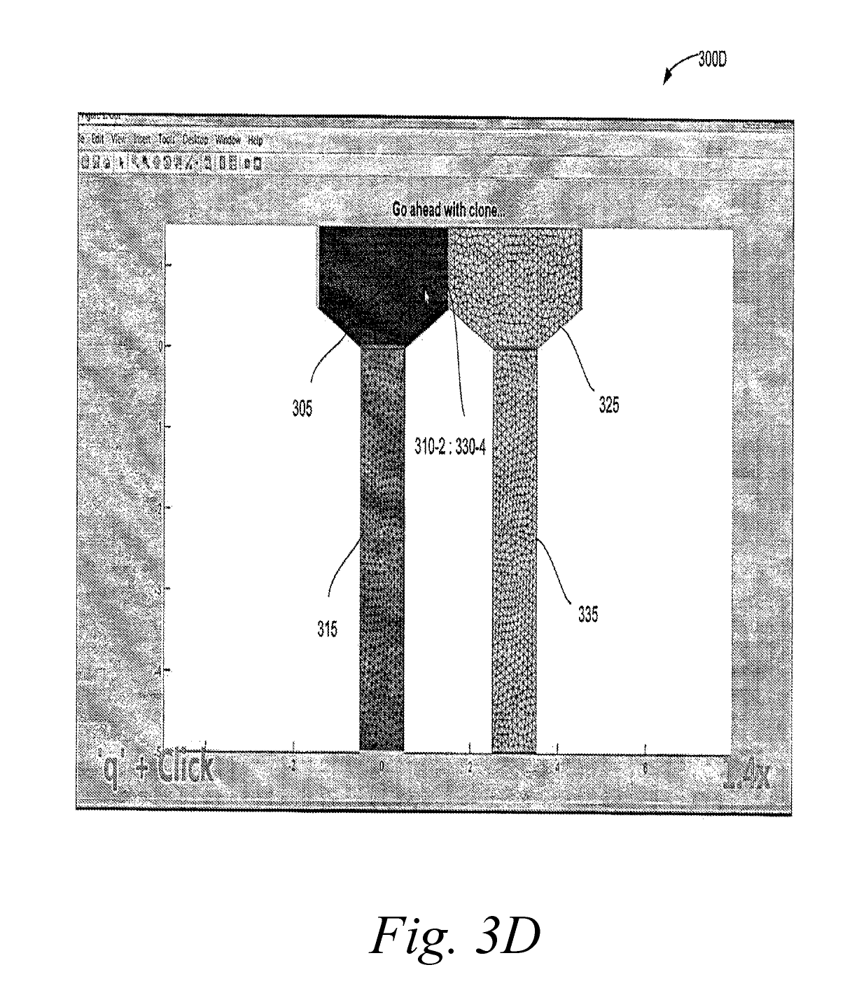

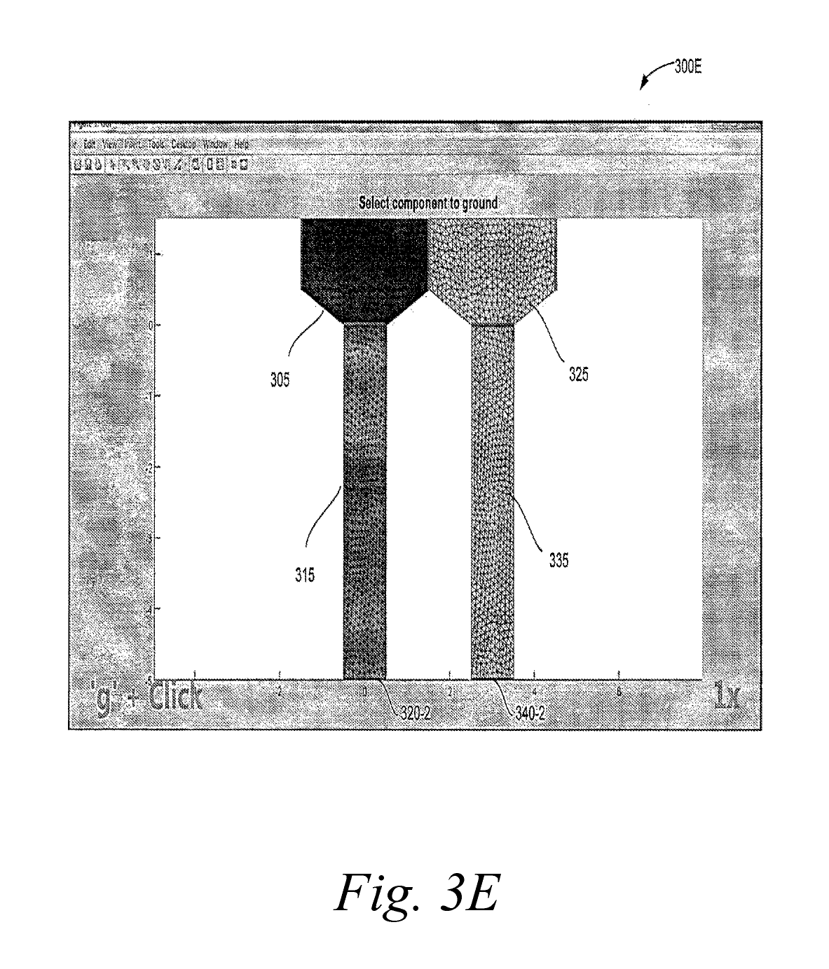

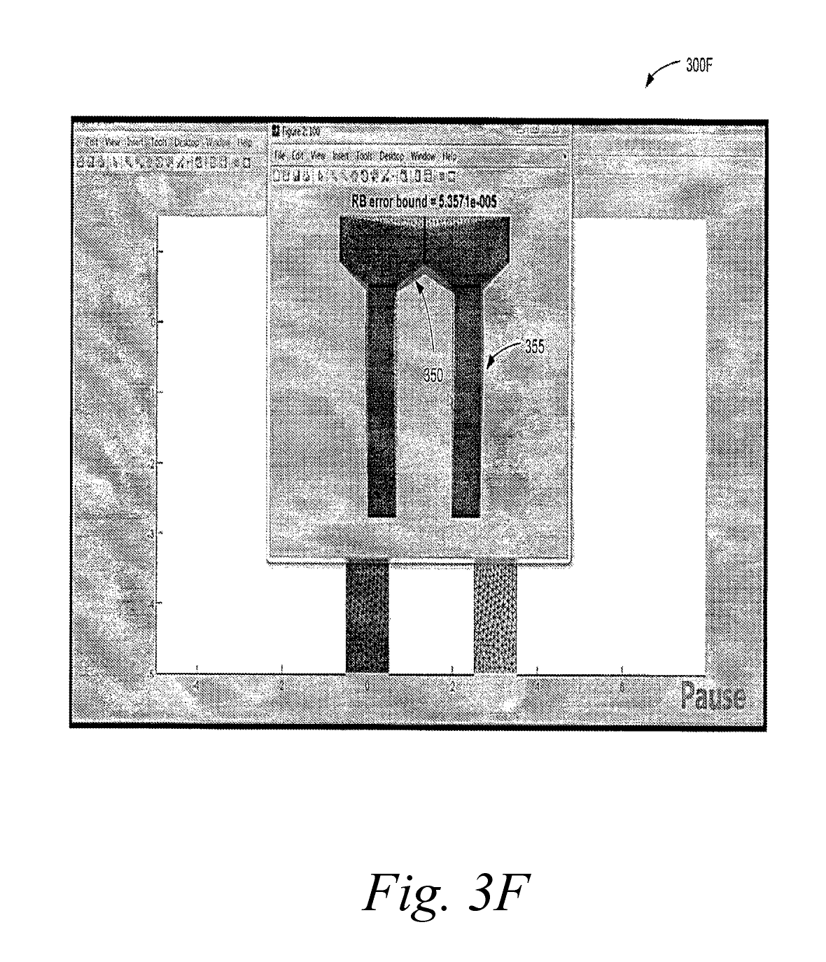

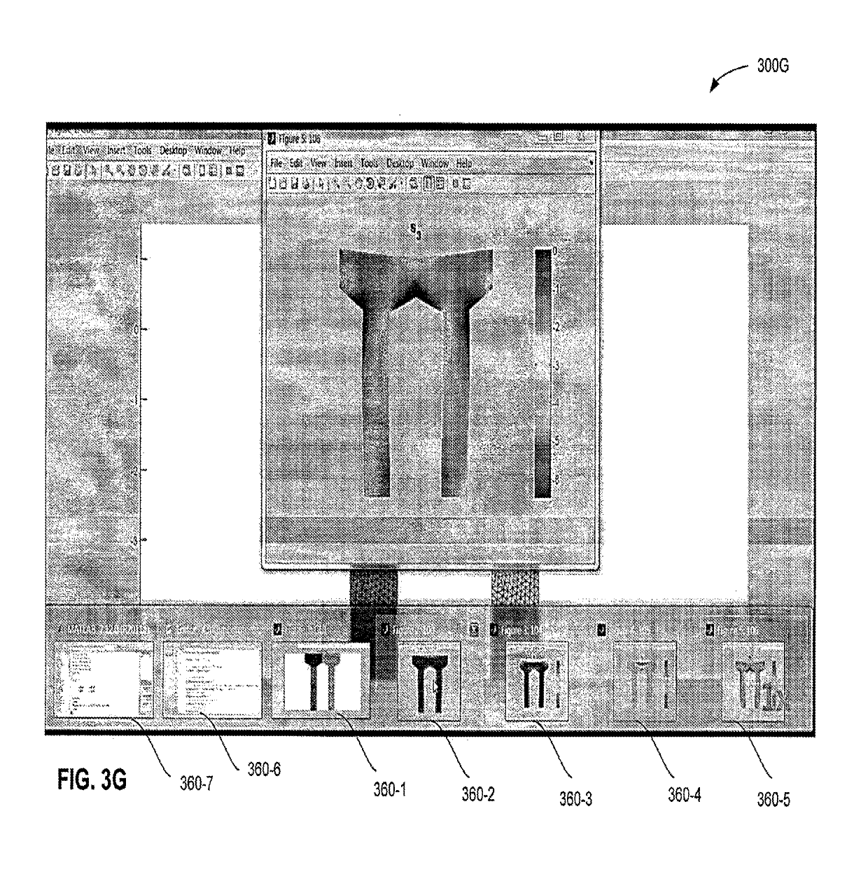

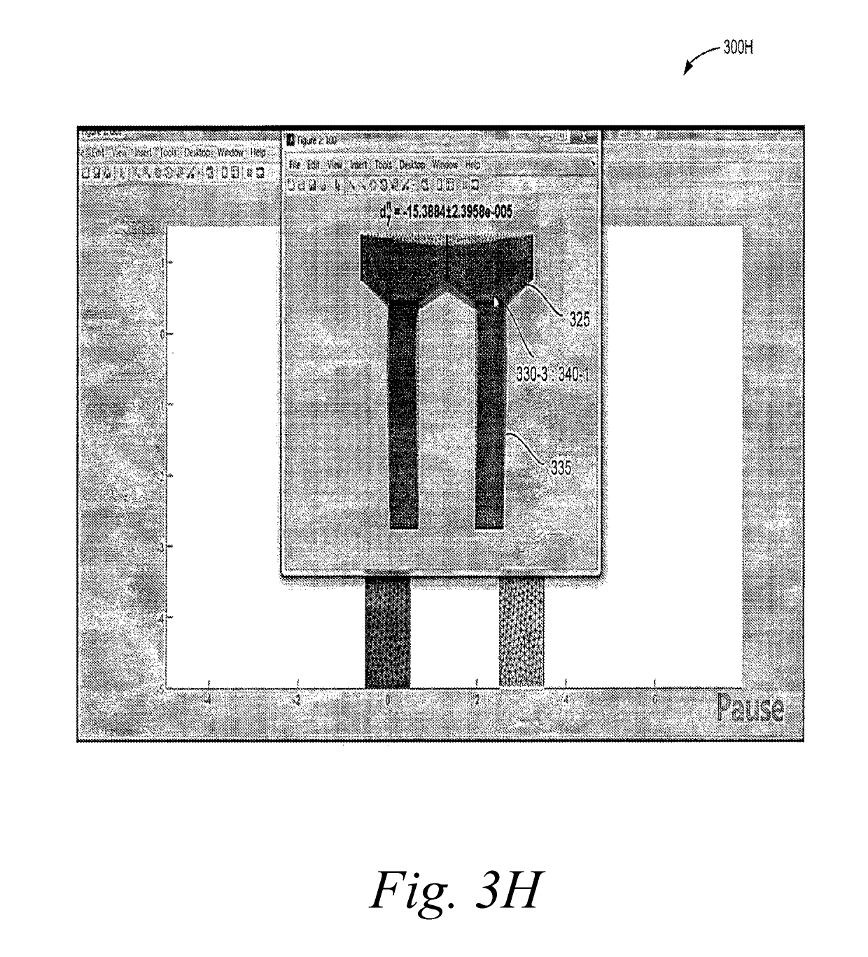

FIG. 2A shows an illustrative process 200 that may be performed by a simulation tool to assist a user in constructing and analyzing a component-based model for a physical system, in accordance with some embodiments. For example, the process 200 may be performed by illustrative simulation tool 104 shown in FIG. 1 during a user session to assist the user in constructing a model and performing an FEA simulation. For purposes of illustration, various acts of the process 200 will be explained with reference to FIGS. 3A-J, which show an example of a series of user interactions relating to an analysis of an arch structure. However, it should be appreciated that aspects of the present disclosure are not limited to the particular graphical user interfaces shown in FIGS. 3A-J, nor to the particular problem analyzed (i.e., arch structures). Rather, various inventive concepts disclosed herein may be used, either alone or in combination, to analyze any suitable physical system.

The simulation tool may receive an identification of a first reference component to be used to create a model of a first component of the physical system being analyzed (205). For instance, as discussed above in connection with FIG. 1, the simulation tool 104 may present to the user a plurality of reference components, such as reference components for which pre-computed datasets are available from one or more libraries (e.g., the reference component library 120 in the example of FIG. 1). The user may browse through the reference components and select one or more of them for use in constructing a model of the physical system being analyzed. Alternatively, the user may obtain identification information regarding a desired reference component in some other suitable manner, such as by looking up a directory of reference components for which pre-computed datasets are available.

The simulation tool may receive one or more parameters for the identified reference component (210). Such parameters may relate to one or more physical characteristic of the component being modeled, such as geometric and material characteristics. However, it should be appreciated that some reference components may not be parameterized, so that no parameters may be received for such reference components.

Referring to FIG. 3A, an illustrative graphical user interface (GUI) 300A is shown, in which a user selects a reference component corresponding to a keystone to create a component 305, in accordance with some embodiments. In this example, the component 305 has four ports, 320-1, 310-2, 310-3, and 310-4, for connecting to other components. The user may specify the geometry of the keystone, for example, by specifying a width of the keystone, a height of the keystone, and/or a size for each of the four ports 320-1, 310-2, 310-3, and 310-4. Alternatively, one or more suitable geometric relationships may be assumed, so that some measurements may be inferred from other measurements. For example, the port 310-4 may, by definition, have the same dimensions as the port 310-2. As yet another alternative, the user may specify an angle of the arch in combination with other dimensions such as the width and height of the keystone.

Although the illustrative GUI 300A shown in FIG. 3A displays a two-dimensional (2D) representation of the component 305, it should be appreciated that the simulation tool may create and manipulate a 2D or 3D mathematical model of the component 305. For example, the component 305 may be assumed to have a uniform depth, which may be specified by the user. In alternative embodiments, a 3D representation of the component 305 may be displayed, and the user may specify depth information using any suitable input method, for example, by clicking and dragging points of interest using a mouse, or by entering depth information into a dialog box.

Returning to FIG. 2A, the simulation tool may receive an identification of a second reference component (215), and may receive, (220), one or more parameters for the second reference component identified at act 215. The acts 215 and 220 may be sin respectively, the acts 205 and 210 described above.

At act 225, the simulation tool may receive an indication that the first and second components specified at acts 205, 210, 215, and 220 are to be connected. For example, with reference to FIG. 3B showing an illustrative GUI 300B, the user may create a component 315 corresponding to a pillar and having ports 320-1 and 320-2, and may indicate that the port 310-3 of the component 305 is to be connected to the port 320-1 of the component 315.

At act 230, the simulation tool may receive an indication that a subsystem including the first and second components specified at acts 205, 210, 215, and 220 are to be cloned. For example, with reference to FIG. 3C showing an illustrative GUI 3000, the user may select the component 305 and the component 315 to form a subsystem for cloning, and may specify that a cloned subsystem is to be connected to the original subsystem at the port 310-2 of the component 305.

FIG. 3D shows an illustrative GUI 300D displaying an arch structure having the components 305 and 315 and two other components 325 and 335, in accordance with some embodiments. The components 325 and 335 may result from cloning the components 305 and 315, as discussed above in connection with act 230 of FIG, 2A. Because the user specified that the cloned subsystem is to be connected to the original subsystem at the port 310-2 of the component 305, the simulation tool may automatically position the components 325 and 335 relative to the components 305 and 315 in such a manner that the port 310-2 of the component 305 is aligned with the port 330-4 of the component 325. For instance, during the cloning process, the simulation tool may automatically infer that the port 310-2 of the component 305 is to be connected to the port 330-4 of the component 325, and may determine an orientation for the cloned subsystem formed by the components 325 and 335 based on an orientation of the port 310-2 of the component 305.

Returning to FIG. 2A, the simulation tool may, at act 235, receive one or more loading and/or boundary conditions. For instance, in the example of the arch structure discussed above, a loading condition may specify a location, a magnitude, and a direction of a force to be applied to the arch structure, whereas a boundary condition may specify how the arch structure is expected to behave at a port that is not connected to any other component in the arch structure. As a more specific example, FIG. 3E shows an illustrative GUI 300E displaying the arch structure having the components 305, 315, 325, and 335, where the user specifies that the port 320-2 of the component 315 and a port 340-2 of the component 335 are to have zero displacement.

Returning to FIG. 2A, the simulation tool may, at act 240, obtain simulation results based on information received from the user and/or other sources. For instance, in some embodiments, the simulation tool may -e the identifying information received at acts 205 and 215 to access pre-computed reference component datasets for the first and second reference components. The simulation tool may then use the component parameters received at acts 210 and 220 and the accessed datasets to construct component models for the first and second components. A component model for a cloned component (e.g., the component 325 in the example of FIG. 3D) may be constructed based on the component model for the corresponding original component (e.g., the component 305 in the example of FIG. 3D), for instance, by applying appropriate translational and/or rotational transformations. The simulation tool may then assemble the component models into a system model and compute one or more output values of interest, for example, by solving one or more partial differential equations.

It should be appreciated that any of the processing tasks associated with the act 240 may be performed by one or more computers different from a computer on which the simulation tool is running. For instance, in some alternative embodiments, the simulation tool may request that a simulation be performed by a server located remotely from the simulation tool, and may send relevant information (e.g., identification of reference components, component parameters, and/or information regarding how various components are connected) to the server and receive simulation results from the server. As another alternative, the simulation tool may request component models from a server (e.g., by providing identification of reference components and/or component parameters), but may perform other tasks locally, such as those tasks related to cloning, assembly, and solving partial differential equations. Other ways of distributing the processing tasks may also be suitable, as aspects of the present disclosure are not so limited.

At act 245, the simulation tool may display the simulation results obtained at act 240 to the user. For instance, with reference to the arch structure example discussed above, the simulation results may include predictions regarding how the arch structure would behave under specified loading and/or boundary conditions. One example of such a prediction is the expected deformation (or displacement;) of the arch structure, which is displayed in an illustrative GUI 300F shown in FIG. 3F. In this example, deformation is expected at various locations, such as vertical displacement of the keystones (e.g., at location 350 as shown in FIG, 3F) and bending of the pillars (e.g., at location 355 shown in FIG. 3F).

In some embodiments, the simulation tool may provide an error bound associated with a simulation result. For instance, in the example shown in FIG. 3F, the simulation tool indicates that an error associated with the displacement prediction is no more than 0.0053571% at any location within the arch structure. This error may indicate a difference between the output of the simulation tool and an output that would have been obtained had a full FEA solution been computed (e.g., according to some suitable FEA technique). As discussed in greater detail below, such a full FEA solution may be used as a reference model in an offline stage of computation. Such an error bound may be derived in a rigorous and verifiable manner so that engineers may rely on the results of the simulation tool with confidence.

It should be appreciated that the simulation results produced by the simulation tool may include other information addition to, or instead of, displacement of a structure. Depending on the particular engineering problem at hand, any suitable output of interest may be computed. For example, in an illustrative GUI 300G shown in FIG. 3G, a user may choose from a number of different displays, 360-2, . . . 360-5, which may show, respectively, the expected displacement and three principal stresses within the arch structure, all of which may be included in the simulation results obtained by the simulation tool. The user may also return to a display 360-1 showing the proposed arch structure, edit simulation parameters via a display 360-6, or interact with another software (e.g., a software for solving partial differential equations) via a display 360-7. Other types of displays providing other functionalities may also be provided, as aspects of the present disclosure are not limited in this manner.

In addition to visually displaying simulation results such as displacement of a structure, the simulation tool may, in some embodiments, allow the user to drill down to more detailed results. For example, in an illustrative GUI 300H shown in FIG. 3H, the simulation tool may allow the user to select the connection between port 330-3 of the component 325 and port 340-1 of the component 335 to see an estimate for the displacement values at that connection. This estimate may be computed in any suitable manner, for example, by taking an average or an upperbound along the connection. A rigorously computed error bound may also be provided for this estimate

While illustrative examples relating to an arch structure are discussed above in connection with FIG. 2A and FIGS. 3A-H, it should be appreciated that various inventive concepts disclosed herein can also be used to analyze other types of structures and other types of engineering problems (e.g., heat transfer, acoustics, fluid mechanics, etc.). Also, aspects of the present disclosure are not limited to any particular number or arrangement of components. For example, as shown in an illustrative GUI 300I of FIG. 31, the cloning feature of the simulation tool may allow a user to rapidly construct a model for a complex structure with many components by taking advantage of repetitions in the complex structure. The simulation tool may provide a rigorously computed error bound for the entire structure, for example, as shown in an illustrative GUI 300J of FIG. 3J, to assist an engineer in managing the risk of error accumulation in a repeated structure.

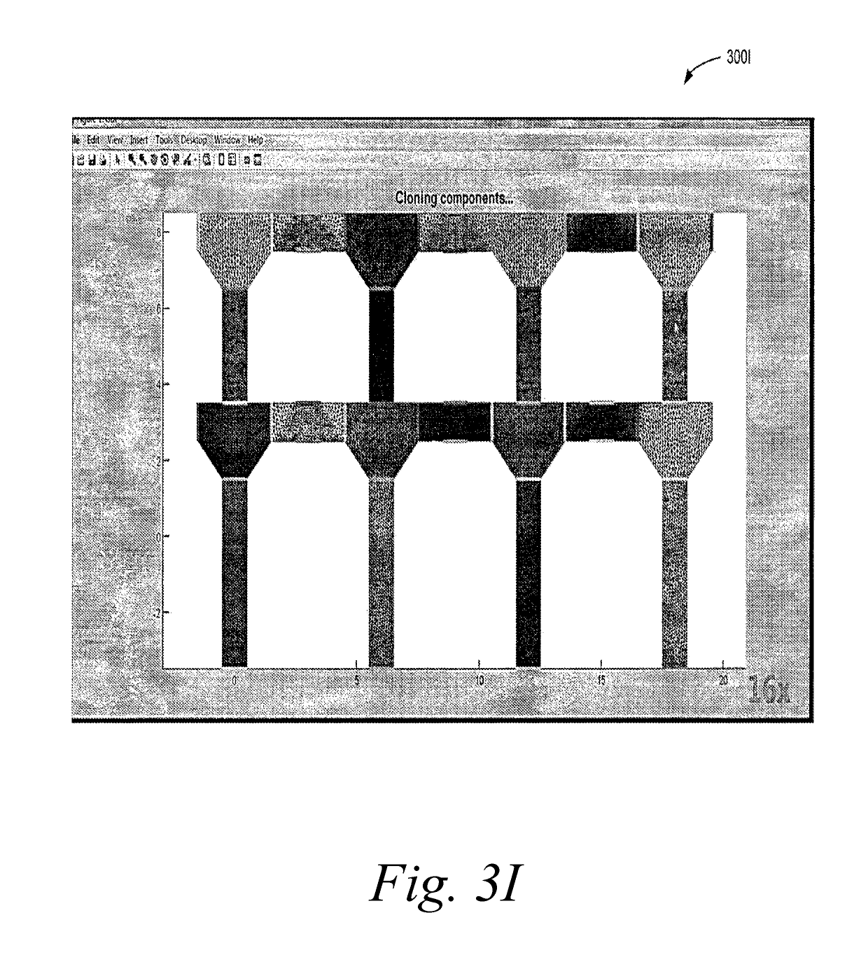

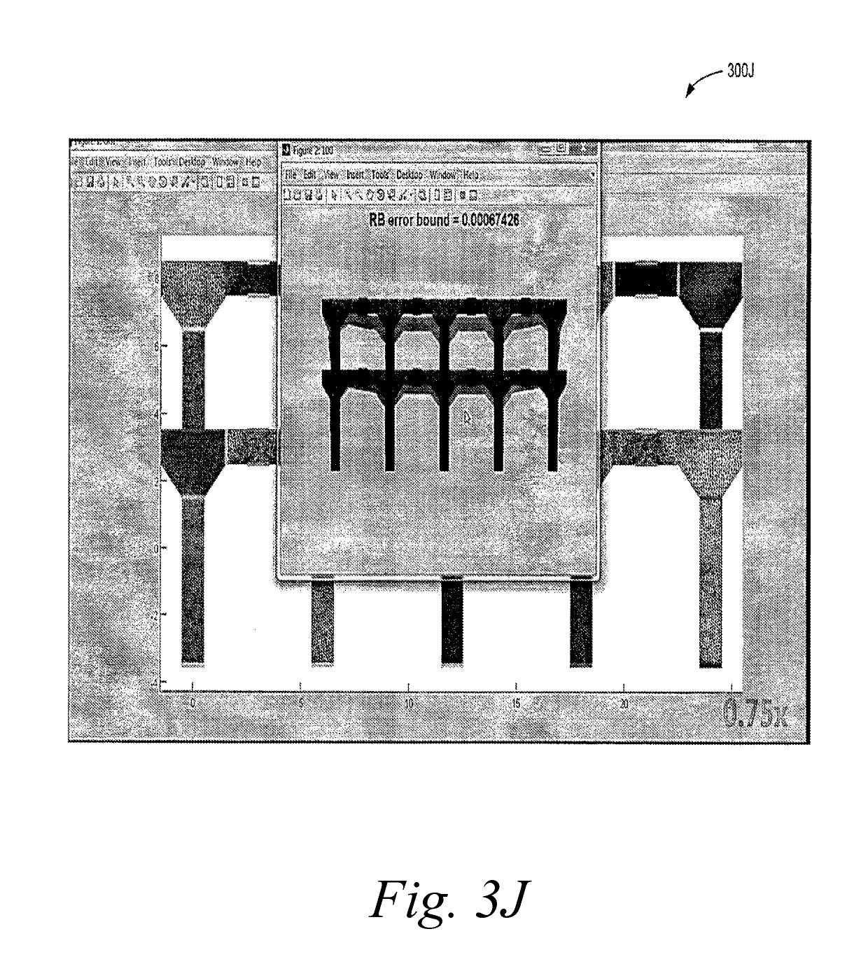

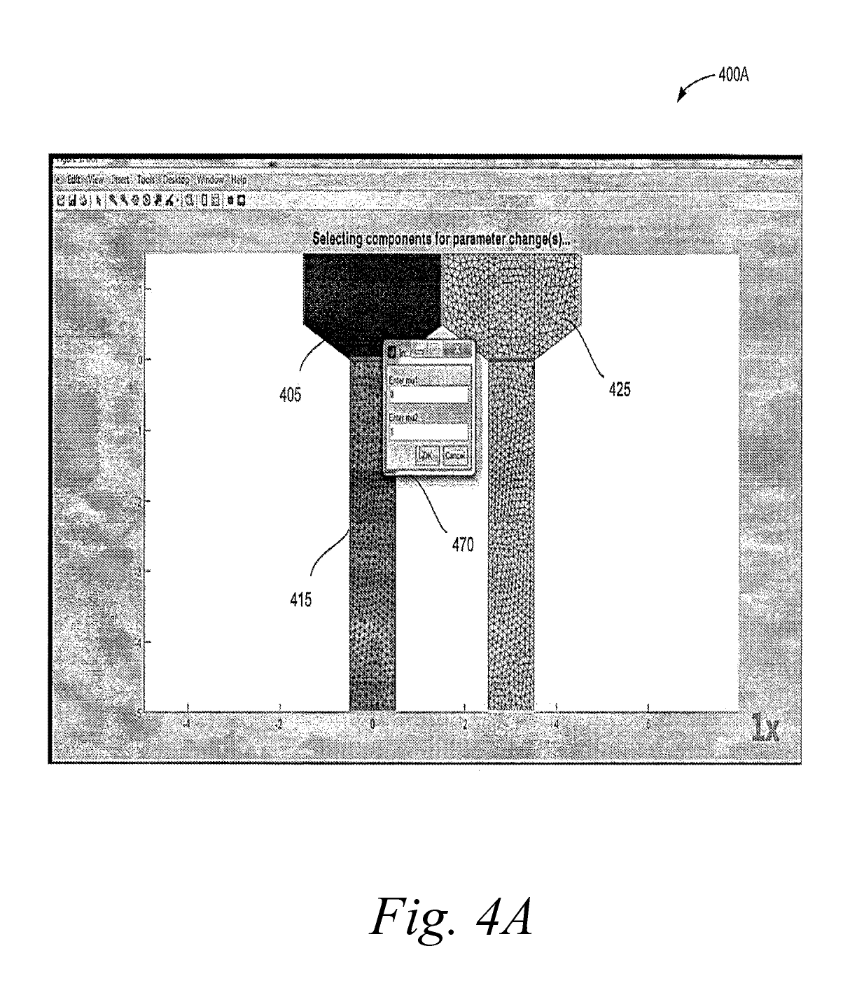

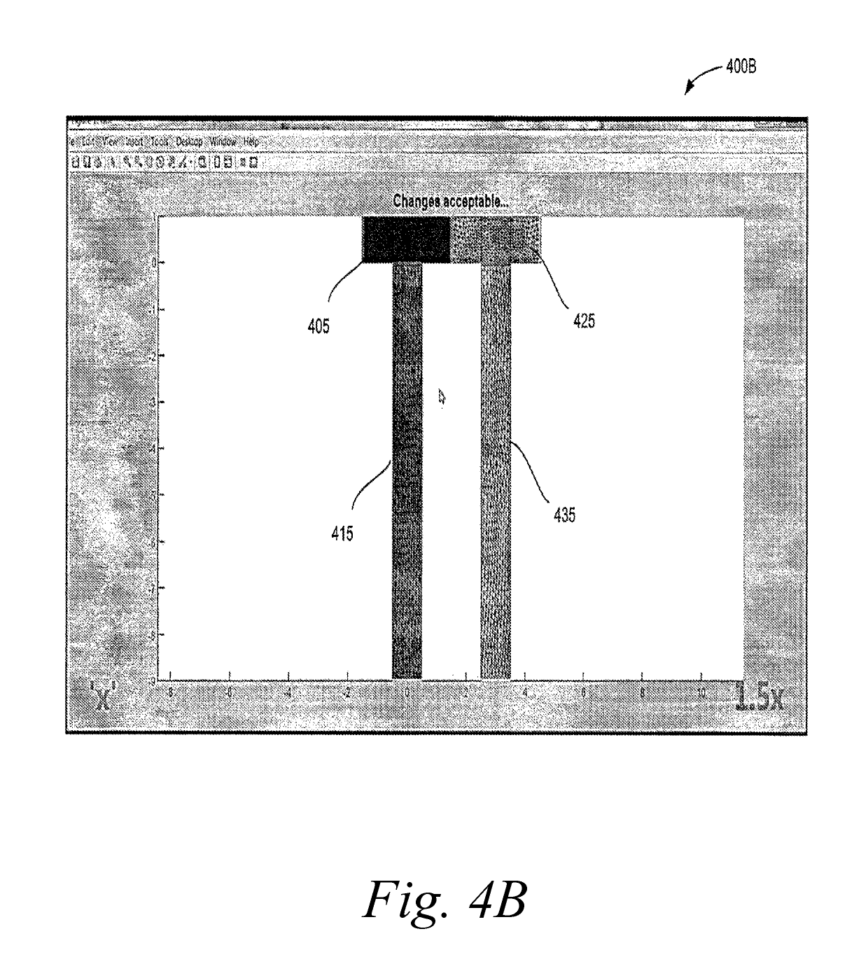

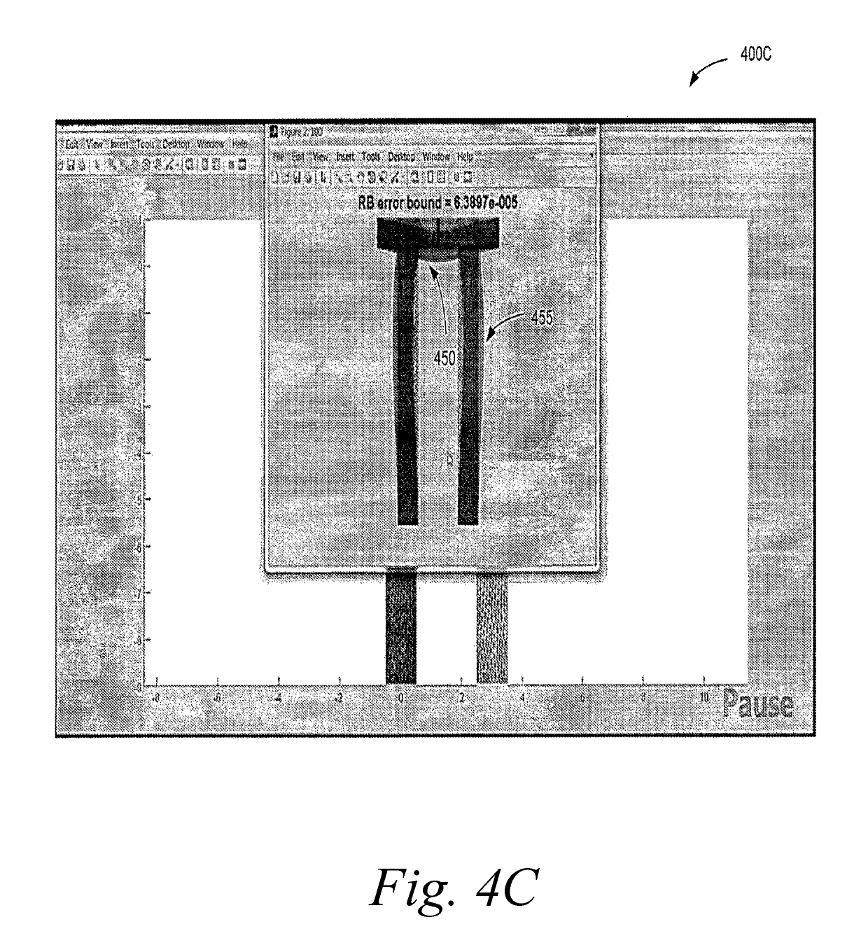

In some embodiments, a simulation tool may allow a user to make modifications to a system after a model has been constructed. In response to such modifications, the simulation tool may construct an updated model and obtain updated simulation results using the updated model. FIG. 2B shows an illustrative process 250 that may be performed by a simulation tool to process one or more modifications to a component-based model of a physical system, in accordance with some embodiments. For purposes of illustration, various acts of the process 250 will be explained with reference to FIGS. 4A-C, which show an example of a series of user interactions relating to modifying an arch structure and analyzing the modified arch structure.

At act 255 of FIG. 2B, the simulation tool may receive an input specifying one or more modifications to model of a physical system (e.g., a component-based model as described above in connection with the illustrative process 200 shown in FIG. 2A). For instance, as shown in an illustrative GUI 400A of FIG. 4A, the simulation tool may allow the user to modify angles of keystone components 405 and 425 in an arch structure. In this example, a dialog box 470 is provided to allow the user to enter the desired angles. However, it should be appreciated that other input methods may also be suitable, for example, by allowing the user to use a pointing device (e.g., a mouse) to select and move one or more lines forming an angle to be changed.

Returning to the example of FIG. 2B, the simulation tool may, at act 260, automatically perform one or more compatibility checks response to a modification requested by the user. For example, if the user attempts to change a geometry parameter of a component, the simulation tool may automatically check whether the modified component is still compatible with the physical system. As a more specific example, if a user attempts to change a width or height of a keystone in an arch structure, the simulation tool may automatically check whether the modified keystone would still fit into the arch structure, which may depend on whether and how the modified keystone is connected to other components in the arch structure, such as other keystones and/or pillars. However, it should be appreciated that other types of incompatibilities may also be checked by the simulation tool, including, but not limited to connecting two components via ports that do not match (e.g., ports that have different sizes and/or shapes), connecting two component in such a way that corresponding interface functions are not oriented consistently, and connecting two components in such a way that the two components occupy a common region in space (which may be impossible in real life).

In the example of FIG. 2B, the simulation tool may, at act 65, attempt to make changes to the physical system other than those requested by the user, for example, to preserve consistency of the physical system. This may be done with or without user approval. For instance, in the example of FIG. 4A, the simulation tool may attempt to move a pillar 415 connected to the keystone 405 if the user requests to increase the width of the keystone 405, so that the pillar 415 remains centered relative to the keystone 405. If the pillar 415 is connected to another component (not shown), the simulation tool may perform another compatibility check to determine whether moving the pillar 415 should trigger yet another change to the physical system. This process may repeat until all compatibility requirements are satisfied, or until some stopping condition is reached, such as the discovery of an incompatibility that the simulation tool does not have sufficient information to resolve. In this manner, changes may be propagating throughout the physical system automatically, which may significantly improve user experience and productivity. However, it should be appreciated that automatic propagation of changes is not required, and the simulation tool may simply alert the user when an incompatibility is detected and allow the user to make further changes.

FIG. 4B shows an illustrative GUI 400B displaying a result of changing an arch angle and pillar height in the illustrative arch structure shown in FIG. 4A. In this example, the user changed the arch angle for the keystone 405 to zero and increased the height of the pillar 415. In response to these changes, the simulation tool may perform one or more consistency checks, and may determine that the arch angle for the keystone 425 and the height of the pillar 435 should also be changed to match the changes to the keystone 405 and the pillar 415. Alternatively, or additionally, the simulation tool may replicate all changes to the keystone 405 and the pillar 415 in the keystone 425 and the pillar 435 because the keystone 425 and the pillar 435 may have been cloned from the keystone 405 and the pillar 415.

Once the proposed changes are confirmed by the simulation tool and/or the user, the simulation tool may process the proposed changes to obtain updated simulation results. For instance, returning to the example of FIG. 213, the simulation tool may obtain updated simulation results at act 270 and display the updated simulation results at act 275. In some embodiments, the processing tasks performed at acts 270 and 275 may be similar to those performed at acts 240 and 245 of FIG. 2A. However, in an embodiment in which a system model is obtained based on multiple component models, some computational savings may be possible. For example, some speedup (e.g., five, ten, or fifteen percent) may be achieved by reusing previously computed data relating to component models that are not directly affected by any modifications, such as component models with no changes to either parameters or connections.

An example of such updated simulation results is displayed in an illustrative GUI 400C shown in FIG. 4C. In this example, significant deformation is expected at various locations, s as vertical displacement of the keystones (e.g., at location 450 as shown in FIG. 4C) and bending of the pillars (e.g., at location 455 as shown in FIG. 4C).

Returning to the example of FIG. 2B, the simulation tool may, at act 280, determine whether further modifications to the physical system maybe desired. For example, based on the results obtained at act 270 and displayed at 275, an engineer may decide to add to the arch structure shown in FIGS. 4B-C one or more reinforcing features such as flying buttresses (not shown). As another example, the engineer may decide to make further changes to parameters of one or more components. If such modifications are desired, the simulation tool may return to act 255 to receive instructions from the engineer to further modify the physical system. For example, the simulation tool may readily construct models for additional components using pre-computed reference component datasets that may be available for the additional components. If, on the other hand, no other modifications are desired, the process 250 may end.

While specific examples of modifications are discussed above in connection with FIGS. 2B and 4A-C, it should be appreciated that aspects of the present disclosure are not limited to any particular types of modifications. For instance, modifications relating loading and/or boundary conditions may be made, in addition to, or instead of, modifications relating to component parameters.

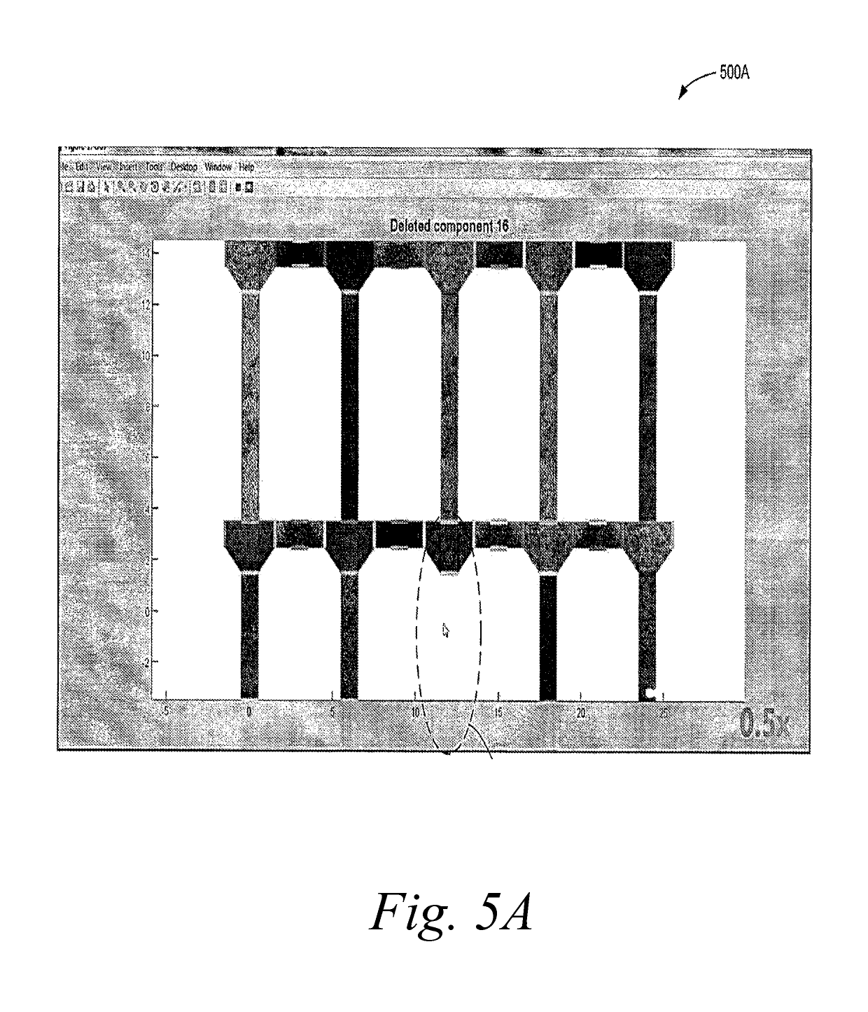

In some further embodiments, a simulation tool may be used to analyze various types of failures, such as a brittle failure in a structure. FIG. 5A shows an illustrative GUI 500A displaying an arch structure in which a pillar has been removed at location 580, so as to analyze how the remaining structure may behave. The simulation tool may construct an updated model, for example, by simply omitting a component model corresponding to the missing pillar during an assembly procedure. The updated model may be analyzed as before, and an example of an updated result is shown in an illustrative GUI 500B of FIG. 5B. In this example, significant deformation is expected at various locations above the missing pillar, such as vertical displacement of the keystones at locations 550 and 555 as shown in FIG. 5B.

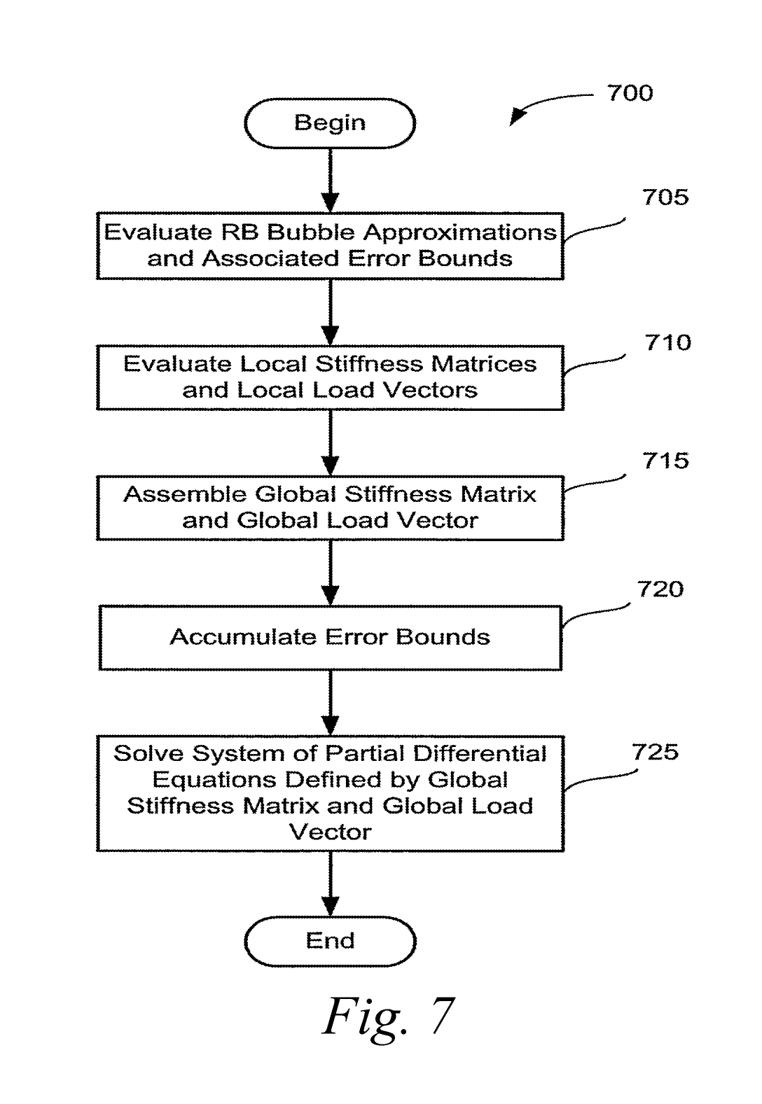

As discussed above and in greater detail below in connection with FIG. 7, a simulation tool may be able to construct update models and obtain updated simulation results in an efficient manner due to the use of pre-computed reference component datasets. However, it should be appreciated that aspects of the present disclosure is not limited to such use. For example, pre-computed data of some other form, or no pre-computed data at all, may be used by a simulation tool in accordance with alternative embodiments.

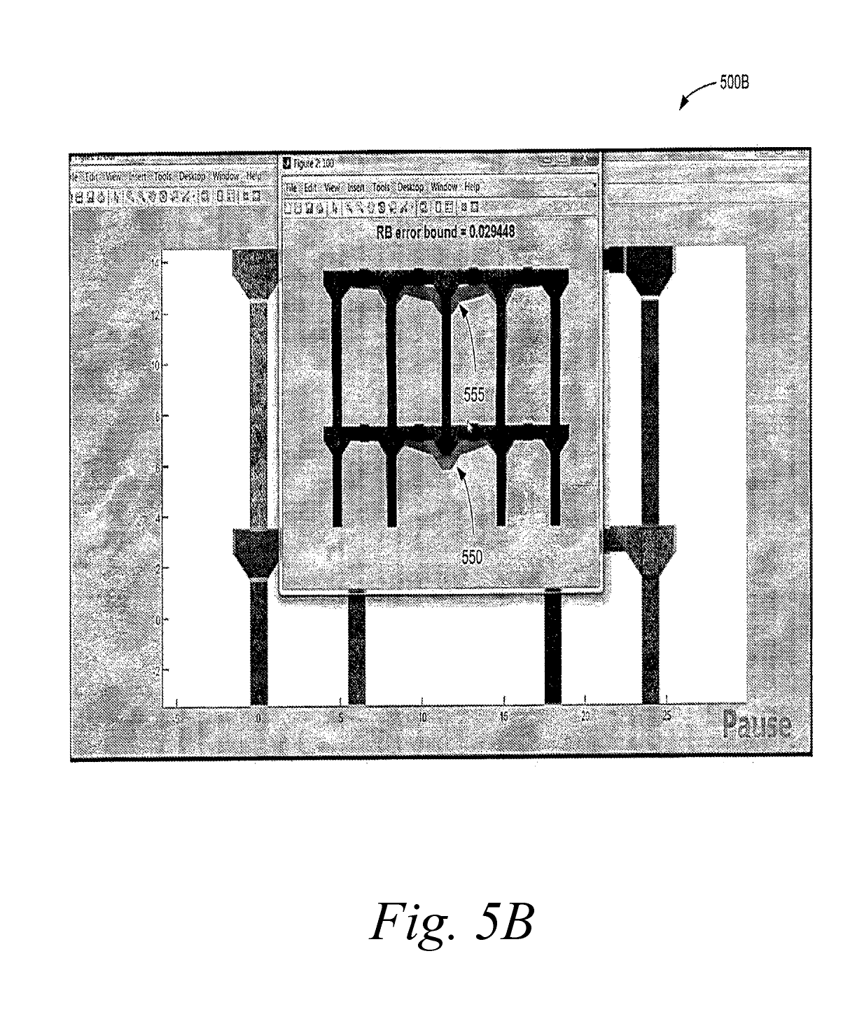

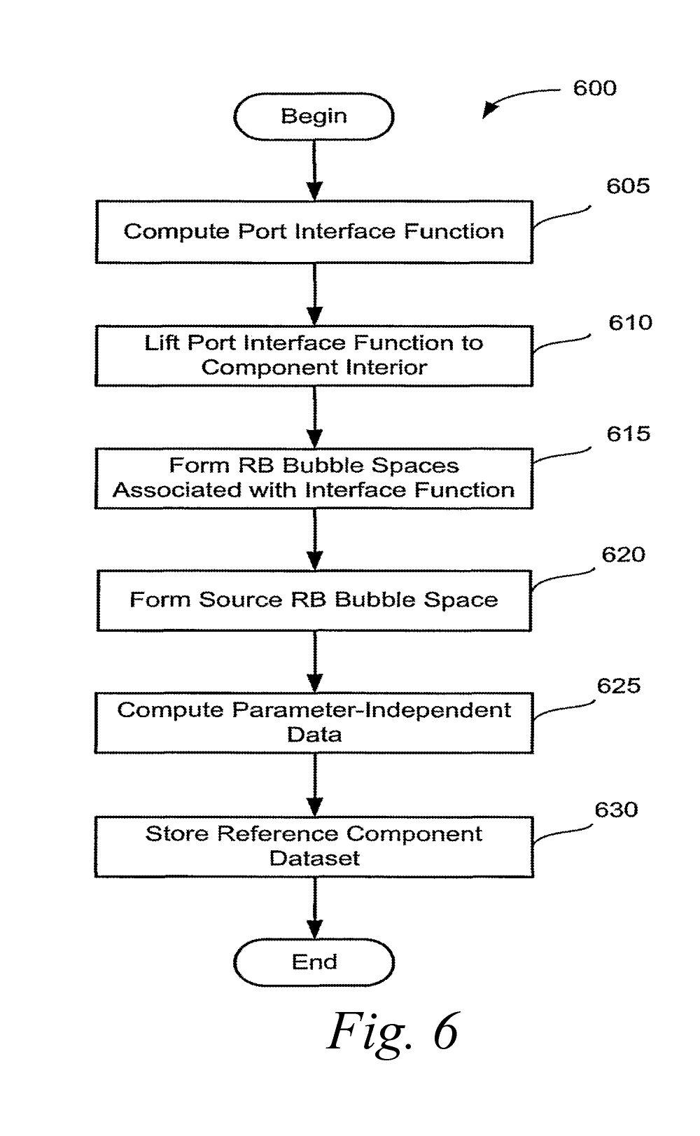

FIG. 6 shows an illustrative process 600 that may be performed to prepare an evaluation dataset for a reference component, in accordance with some embodiments. For example, the process 600 may be performed by a simulation tool as part of a process of modeling and analyzing a physical system (e.g., the illustrative process 200 in the example of FIG. 2A). Alternatively, the process 600 may be performed independently of a physical system to be analyzed. For example, the process 600 may be performed during an offline stage, before a physical system to be analyzed is fully specified. The resulting evaluation dataset may be used during an online stage to analyze a physical system, once the physical system is fully specified.

As discussed above, a reference component may conceptually represent a component type, such as a component with one or more parameters unspecified. For purposes of illustration, the process 600 is described below with reference to a pillar with unspecified length and width as an example of a reference component. However, it should be appreciated that the illustrative process 600 may be performed to prepare evaluation datasets for other reference components, as aspects of the present disclosure are not limited in this respect.

At act 605, one or more interface functions may be computed on a port of a reference component. In the example of a pillar, there may be two ports, one at each end of the pillar, for connecting to other components such as keystone components or other pillar components. If the pillar is modeled as a 3D object, a port may be a 2D surface.

At act 610, an interface function computed at act 610 may be lifted into the interior of the reference component in any suitable fashion. For instance, with reference again to the example of a 3D pillar, an interface function computed on a 2D port may be extended to an interface function defined in 3D space so that the 3D interface function may take on the same value (which may be non-zero) as the 2D interface function anywhere on the port, while diminishing into the interior of the pillar in a smooth fashion and becoming zero at any other port. Once an interface function has been lifted into the interior of a component, the interface function can be used to indicate some quantity of interest (e.g., displacement in a structural analysis problem or temperature in a heat transfer problem) in the component. It should be appreciated that components and ports may have other dimensionalities, as aspects of the present disclosure are not limited to models of any particular dimensionality. Furthermore, any suitable number of interface functions may be computed for each port of the reference components. For example, in some embodiment, more interface functions may be computed to reduce error, even though having more interface functions may lead to a higher computational load.

At act 615, a reduced basis technique may be applied to form one or more RB bubble spaces associated with an interface function computed at act 610. In some embodiments, an RB bubble space may have as elements linear combinations of one or more basis functions, so that forming an RB bubble space may include identifying the one or more basis functions. As discussed in greater detail below in connection with FIG. 7, an RB bubble space associated with an interface function may be used to approximate a bubble function associated with the interface function, where both the bubble function and the interface function may be used in computing a local stiffness matrix and a local load vector of a component.

In one implementation, a basis function for forming an RB bubble space may be obtained by randomly selecting a set of one or more parameters for the reference component (e.g., a length and a width for the pillar), solving one or more partial differential equations corresponding to the selected set of parameters, and using the solution to obtain the basis function. In an alternative implementation, basis functions may be obtained using an iterative greedy algorithm. For example, an iterative greedy algorithm may be initialized by selecting a training set of parameters for a reference component (e.g., multiple combinations of lengths and widths for the pillar). At each iteration of the algorithm, an error estimate, based on a current set of basis functions, may be evaluated for some or all of the parameters in the training set, and a set of one or more parameters at which the error estimate is maximized may be selected. A solution corresponding to the selected set of one or more parameters may then be used to obtain a basis function. This new basis function may be added to the set of basis functions, and the algorithm may proceed to the next iteration. The algorithm may terminate when some desired number of basis functions is reached, or when an error tolerance over the training set is satisfied.

While random selection and greedy selection are described above as alternative techniques for identifying a basis function, it should be appreciated that other techniques for identifying a basis function may also be possible, as aspects of the present disclosure are not limited in this respect. Furthermore, as described above in the example of a greedy algorithm, a process fur selecting a basis function may be performed any suitable number of times to obtain any suitable number of basis functions, for example, based on a desired tradeoff between accuracy and computational efficiency. As a more specific example, an error tolerance may be used, so that more basis functions may be added until an estimated error is below the selected error tolerance.

At act 620, a source RB bubble space may be formed using any of the techniques described above, or any other suitable technique. As discussed in greater detail below in connection with FIG. 7, a source RB bubble space may be used to approximate a source bubble function, which may in turn be used in computing a local load vector f a component. Such a source bubble function may represent an input to a physical system being analyzed, such as a heat source in a heat transfer application or a force or load in a solid mechanics application.

At act 625, certain parameter-independent data may be computed, which may be used during an online stage to analyze a physical system that includes an instance of the reference component with all parameters specified. In some embodiments, parameter-independent data computed at act 625 may include one or more inner products of functions that are independent of those parameters that are not yet specified during an offline stage. Computing such parameter-independent data ahead of time y speed up the online stage significantly, so that simulation results may be delivered to a user in real time.

Act 630, some or all of the data computed at acts 605, 610, 615, 620, and 625 may be organized into a dataset and stored in such a manner that the dataset may be later retrieved by identifying the associated reference component (e.g., the pillar). As discussed before, computing and storing such a dataset ahead of time may speed up the online stage significantly, and may allow the computational overhead to be amortized over multiple instantiations of a reference component.

Although specific examples are described above for data that may be included in a reference component dataset and for techniques that may be used to prepare such data, it should be appreciated that aspects of the present disclosure are not limited to any particular type of data to be included in a reference component dataset, nor to any particular technique for computing such data. For instance, where multiple interface functions are computed, a single RB bubble space may be used for all of the interface functions. Alternatively, a different RB bubble space or set of RB bubble spaces may be computed for each interface function. A combination of these two approaches may also be possible, for example, by having some, but not all, of the interface functions share an RB bubble space or set of RB bubble spaces. Furthermore, any suitable software may be used to solve partial differential equations, for example, in a process for selecting basis functions at act 615.

FIG. 7 shows an illustrative process 700 that may be performed to instantiate component models and evaluate a system model, in accordance with some embodiments. For example, the process 700 may be performed by a simulation tool as part of a process of modeling and analyzing a physical system (e.g., the illustrative process 200 in the example of FIG. 2A). As a more specific example, the process 700 may be performed during an online stage, after a physical system to be analyzed is fully specified, and may make use of reference component datasets computed for various reference components used in creating a model of the physical system.

At act 705, an approximation may be computed for each source bubble function and each bubble function associated with each interface function for each component in the physical system using a reference component dataset corresponding to the component. In some embodiments, such an approximation may be computed as a suitable linear combination of basis functions from a corresponding RB bubble space. For instance, a so-called Galerkin method may be used to select coefficients for scaling the basis functions based on the particular set of one or more parameters specified for the reference component. Additionally, an error estimate may be computed that is indicative of a difference between each “true” bubble function and the corresponding approximation.

At act 710, a local stiffness matrix and a local load vector may be computed for each component in the physical system. The local stiffness matrix and the local load vector may define one or more partial differential equations that predict how a component may behave given some particular set of parameters, boundary conditions, and/or loading conditions. In some embodiments, the local stiffness matrix and the local load vector may be computed using both a corresponding reference component dataset and data computed based on the particular set of parameters, boundary conditions, and/or loading conditions that may not have been specified until the online stage of computation.

At act 715, the local stiffness matrices computed for various components at act 710 may be assembled into a global stiffness matrix for the entire physical system, and likewise for a global load vector. In some embodiments, the assembly process may include, at each connection between two components, adding contributions from both components at the corresponding ports.

At act 720, error bounds computed at act 705 may be accumulated to obtain one or more error bounds for the entire physical system or a portion thereof. For instance, in some embodiments, a global error bound may be obtained by adding error bounds corresponding to all bubble function approximations used for all components. A local error bound for an individual component may then be obtained by post-processing the global error bound.

At act 725, a system of one or more equations specified by the global stiffness matrix and the global load vector, which may provide an approximation to a system of one or more partial differential equations associated with the entire physical system, may be solved to predict how the physical system may behave given the particular set of parameters, boundary conditions, and/or loading conditions. For instance, in the example of an arch structure, a system of one or more equations corresponding to a global stiffness matrix and a global load vector may be solved to predict how much deformation or stress may be experienced at various points in the arch structure.

Again, it should be appreciated that the various techniques described above in connection with FIG. 7 are merely illustrative, as aspects of the present disclosure are not limited to any particular techniques for defining and solving partial differential equations for predicting system behavior. For instance, once a system of one or more equations corresponding to a global stiffness matrix and a global load vector is specified, any suitable software may be used to solve such a system. Thus, act 725 of the process 700 may include preparing a representation of the system of one or more partial differential equations that is compatible with a desired software for solving partial differential equations, running the software with that representation as input, and receiving results from the software.

Some embodiments of methods for implementing static condensation reduced basis element methods are described in U.S. Pat. No. 9,213,788, which is incorporated herein by reference.

Following below are detailed mathematical formulations and proofs for a static condensation reduced basis element method in accordance with some embodiments of the present disclosure. It should be appreciated that such examples of specific implementations and applications are provided solely for purposes of illustration, and that the various inventive concepts presented herein are not limited to any particular implementation or application, as other implementations and applications may also be suitable.

We define here a linear elasticity model which will serve to describe the PR-SCRBE-FE method. We shall affix to certain quantities a subscript “LIN” to emphasize that the model to which the quantity pertains is linear; this subscript, appropriately re-interpreted, will then permit us to directly apply the results of the current section to the linear-nonlinear heterogeneous approximation of the next section. p We first define model parameter P′-tuple μ′ in parameter domain [symbol] ′⊂ [symbol] ^{P}′. (The prime serves to distinguish the parameter here from the parameter of the linear-nonlinear problem in the next section.) We then introduce our parametrized spatial domain Ω_{LIN}(μ′f)⊂ [symbol] ³ with (non-empty) Dirichlet boundary an ∂Ω_{LIN,D}(μ′), associated function space X_{LIN}(μ′)≡{ν∈(H¹(Ω(μ′)))³|ν|_{∂Ω}_{_{LIN,D}}_{(μ′)}=0}, and parametrized bilinear and linear forms α(⋅,⋅; μ′):X_{LIN}(μ′)×X_{LIN}(μ′)→ [symbol] and f(⋅; μ′): X_{LIN}(μ′)→ [symbol] , respectively. The bilinear form shall be given by

$$a ( w , v ; {μ}^{′} ) ≡ {\int }_{{Ω}_{LIN} ( {μ}^{′} )} \frac{\partial {w}_{i}}{\partial {x}_{j}} {E}_{ijk 𝓁}^{elas} ( {μ}^{′} ) \frac{\partial {v}_{k}}{\partial {x}_{𝓁}} dx ; \qquad ( 1 )$$

here Eᵢⱼₖₗ^{elas}(μ′)=λ₁(μ′)δᵢⱼδₖₗ+λ₂(μ′)(δᵢₖδⱼₗ+δⱼₖ), where δᵢⱼ is the Kronecker-delta symbol and λ₁ and λ₂ are respectively the first and second Lamé constants. It is readily demonstrated that a is continuous and coercive over X_{LIN}(μ′). The linear form f may be any bounded linear functional over X_{LIN}(μ′), and will typically include both body forces (such as self-weight) and surface tractions. Note we assume summation over repeated (coordinate) indices. Note also that here we consider elasticity, but the methodology also applies to other types of physical systems, e.g. modeling of thermal, or acoustics; as will be understood by those of ordinary skill in the art, the methods and systems described herein are not limited to equation 1 only.

We may then state our problem: Given model parameter μ′∈ [symbol] ′, find u_{LIN}(μ′)∈X_{LIN}(μ′) such that

a(u_{LIN}(μ′), ν_{LIN; μ′)-}f(ν_{LIN; μ′)=}0, ∀ν_{LIN}∈X_{LIN}(μ′). (2)

Note the parameter μ′ will include geometric parameters, related to Ω_{LIN}(μ), and also non-geometric parameters, for example related to the Young's modulus, E, and Poisson's ratio, ν^{Poisson}, which appear in the Lamé constants.

We define a library as (i) a set of n^{arch} parametrized archetype components which share a common partial differential equation, and (ii) a set of n^{fid} fiducial ports. We describe first the former and then the latter.

Each archetype component α, 1≤α≤n^{arch}, is defined by several attributes. One attribute is a parameter P^{α}-tuple ν^{α} in parameter domain V^{α}⊂ [symbol] ^{p}^{^{α}}. Another attribute is a physical spatial domain, Dᵥ^{α} Note in quantities in which a already appears as label we will typically suppress the superscript α in any associated v^{α}. The elements of the parameter vector v^{α} that characterize the physical spatial domain are referred to as “geometric parameters”; the remaining parameters, for example related to material properties such as Young's modulus, Poisson's ratio, and density, are referred to as “non-geometric” parameters A third attribute is a reference spatial domain \hat{D}^{α}=D_{\hat{v}}^{α} and associated parameterized geometric mapping [symbol] ᵥ^{α}: [symbol] ³→ [symbol] ³ such that the archetype component physical domain Dᵥ^{α} is related to the archetype component reference domain by [symbol] ᵥ^{α}(\hat{D}^{α}); here \hat{v}^{α}∈V^{α} is the reference parameter value such that [symbol] _{\hat{v}}^{α} is the identity. We shall denote a point in Dᵥ^{α} (respectively, \hat{D}^{α}) by x≡(x₁, x₂, x₃) (respectively \hat{x}≡(\hat{x}₁, \hat{x}₂, \hat{x}₃)). For our purposes here, we presume that [symbol] ᵥ^{α}= [symbol] ᵥ^{α}= [symbol] ᵥ^{rot α} [symbol] ᵥ^{def α}, where [symbol] ᵥ^{rot α} is a pure rotation independent of \hat{x}, and [symbol] ᵥ^{def α} is any deformation which does not rotate the ports relatively. Note that the mapping [symbol] ᵥ^{α} will in fact depend only on the geometric parameters. A fourth attribute is a partial differential equation of interest—in our case here, isotropic linear elasticity—expressed as parametrized bilinear and linear forms, âᵥ^{α} and \hat{f}ᵥ^{α}, respectively, over the reference spatial domain \hat{D}^{α}. We recall the standard mapping: given the bilinear form over the component physical spatial domain,

$${a}_{v}^{α} ( w , v ) ≡ {\int }_{{D}_{v}^{α}} \frac{\partial {w}_{i}}{\partial {x}_{j}} {E}_{ijk 𝓁}^{elas} ( v ) \frac{\partial {v}_{k}}{\partial {x}_{𝓁}} dx , \qquad ( 3 )$$

we effect the change of variable (w, ν)=( [symbol] ᵥ^{rot α}ŵ, [symbol] ᵥ^{rot α}\hat{ν}) ∘( [symbol] ᵥ^{α})⁻¹, x= [symbol] ᵥ^{α}(\hat{x}), to obtain the blinear form over the component reference domain,

$${\hat{a}}_{v}^{α} ( \hat{w} , \hat{v} ) ≡ {\int }_{{\hat{D}}^{α}} \frac{\partial {\hat{w}}_{i}}{\partial {\hat{x}}_{j}} {( {v}_{def α}^{} )}_{{jj}^{′}}^{- 1} {E}_{{ij}^{′} k {𝓁}^{′}}^{elas} ( v ) {( {v}_{def α}^{} )}_{𝓁 {𝓁}^{′}}^{- 1} \frac{\partial {\hat{v}}_{k}}{\partial {\hat{x}}_{𝓁}} \vert {v}_{def α}^{} \vert d \hat{x} , \qquad ( 4 )$$

such that aᵥ^{α}(w, ν)=\hat{α}ᵥ^{α}(ŵ, \hat{ν}). Here [symbol] ᵥ^{def α} is the Jacobian associated with [symbol] ᵥ^{def α}, and ∘ denotes composition. A similar procedure relates the physical-domain fᵥ^{α} to the reference-domain \hat{f}ᵥ^{α}. Note that âᵥ^{α} and \hat{f}_{c}^{α} depend on both the non-geometric parameters and, through the mapping functions, the geometric parameters as well. The reference-domain formulation is crucial to the accuracy and efficiency of the PR-SCRBE-FE formulation. A fifth attribute is a set of I reference-domain “ports,” \hat{γ}^{α,i}, 1≤i≤1, in ∂\hat{D}^{α}\\hat{γ}_{D}^{α}, and corresponding physical-domain ports γᵥ^{α,i}= [symbol] ᵥ^{α}(\hat{γ}^{α, i}); here \hat{γ}_{D}^{α} is the portion of the reference domain over which Dirichlet conditions are applied (on all components of the field). The ports shall serve to connect instantiated archetype components. For purposes of exposition we shall assume that I=2; the more general case, which permits I=0, I=1, and I>2, presents no new complications. We shall also assume that the ports are mutually disjoint; the more general case, in which ports may share a vertex or edge, does present new complications, but may be accommodated through a wire-basket approach which comprises “vertex” ports and “edge” ports as well as “face” ports. A sixth attribute is a finite element mesh and associated finite element approximation space \hat{X}^{h;α} defined over the reference spatial domain \hat{D}^{α}; note \hat{X}^{h;α}⊂{ν∈(H¹(\hat{D}^{α}))³|ν|_{\hat{γ}}_{_{D}}_{^{α}}=0}. We further introduce associated bubble spaces, \hat{X}_{bub}^{h;α}≡{ν∈\hat{X}^{h;α}|ν|_{\hat{γ}}_{^{α,i}}=0, i=1, 2}. We denote the dimensions of \hat{X}^{h;α} and \hat{X}_{bub}^{h;α} by [symbol] ^{h;α} and [symbol] _{bub}^{h; α}, respectively.

We next describe the set of n^{fid} fiducial ports γₖ^{fid}, 1≤k≤n^{fid}. In any given archetype component α, each reference port \hat{γ}^{α,i} must be the image of some fiducial port γ_{k(α,i)}^{fid} through a parameter-independent map τ^{α,i}; \hat{γ}^{α,i}=τ^{a,i}(γ_{k(α,i)}^{fid}); typically, τ^{α,i} is a rotation and translation and uniform dilation. Many archetype component reference-domain ports, and in particular reference-domain ports associated with different archetype components, will share the same fiducial port. For simplicity of presentation, we shall henceforth assume that n^{fid}=1, however the general case is readily treated, and indeed illustrated in one of our examples. We associate to our (now, single) fiducial port γ^{fid}≡γ₁^{fid} a set of linearly independent finite element functions χⱼ^{h;fid}, 1≤j≤ [symbol] ^{h}, such that, for each archetype component a in the library, the restriction of any function in \hat{X}^{h;α} to \hat{γ}^{α,i} can be expressed as a unique linear combination of the χⱼ^{h;fid}∘(τ^{α,i})⁻¹, 1≤j≤ [symbol] ^{h}, in practice, this constraint is operationalized as a requirement on the archetype component mesh. Note that, under our assumption that each component has two ports, [symbol] ^{h;α}= [symbol] _{bub}^{h;α}+2 [symbol] ^{h}.

We now indicate how we assemble components into a system associated to our model (2). For any given μ′∈ [symbol] ′, we associate to our model an assembly—or system—of n^{inst}(μ′) instantiated (archetype) components connected at compatible pairs of ports. Regarding instantiation, each instantiated component l corresponds to some archetype component α(μ′, l) in our library for some admissible value of archetype component parameter v^{α}(μ′, l)∈V^{α}; instantiated components which originate in the same archetype component can (and typically will) be assigned different component parameter values. We note that, for our distributed systems, v^{α}(μ′, l) for a given instantiated component will often depend on only a few elements of the model parameter μ′∈ [symbol] ′. We may also define, for instantiated component l, instantiated component ports, γ_{v(μ′,l)}^{α(μ′,l),i}, for i=1(port1) and i=2(port2). We emphasize that the model parameter may include not only variables which relate to geometry but also variables which relate to topology: different values of μ′∈ [symbol] ′ may correspond to different sets of instantiated components; hence the notation n^{inst}(μ′) and α(μ′, l) rather than simply n^{inst} and α(l), respectively.

Regarding connection, the system may be described by a set E^{connect}(μ′) which comprises compatible pairs of instantiated (component, component port) couples: for example, the pair {(1,1), (3,2)} refers to the connection of instantiated port 1 of instantiated component 1 to instantiated port 2 of instantiated component 3; note we shall refer to component ports by “number” as well as by domain, whichever is more convenient. The compatibility requirement is simply that the two instantiated ports must coincide: for pair {(l,i),(l′,i′)}, γ_{v(μ′,l′)}^{α(μ′,l′),i′}=γ_{v(μ′,l)}^{(μ′,l),i}; in general, two instantiated ports in any given connection pair will share the same fiducial port. We then introduce n^{glob}(μ′) global ports Γ₁, . . . , Γₙ_{^{glob}}_{(μ′)}: each global port is the coalescence of two connected ports associated with a pair in E^{connect}(μ′); the latter is summarized by a map [symbol] (μ′) from connection pairs in E^{connect} to corresponding global ports. Note that different parameter values may and often will correspond to different sets of connections and global ports; hence the notation E^{connect}(μ′), n^{glob}(μ′), and [symbol] (μ′) rather than simply E^{connect}, n^{glob}, and [symbol] , respectively. Finally, we note that instantiated ports may reside on ∂Ω_{LIN}(μ′), in which case by convention the second member of the connection pair shall be null and there is no compatibility requirement.¹ We shall refer to global ports both by “number” and by domain, whichever is most convenient. The algorithm extends readily to any number of archetype component ports, I. In the case in which I=0, the entire system is a single instantiated component, and PR-SCRBE-FE reduces to RB(-FE).

Our model reduction approach is built upon what we shall denote the underlying finite element approximation. Our finite element approximation space, X_{LIN}^{h}(μ′), is constructed from our system description. In particular, X_{LIN}^{h}(μ′) is formed by “stitching together” the finite element spaces associated with each instantiated component; the latter, in turn, are induced by the finite element spaces associated with archetype component reference domains. More precisely,

X_{LIN}^{h}(μ′)≡{ν∈X_{LIN}(μ)∥(( [symbol] _{v(μ′,l)}^{rot α(μ,′l)})⁻¹ν)|_{D}_{_{v(μ′,l)}}_{^{α(ν′,l)}}∘ [symbol] _{v(μ′,l)}^{α(μ′,l)}∈\hat{X}^{h;α(μ′,l)}, 1≤l≤n^{inst}(ν′)}. (5)

Note that the conforming condition is very easily satisfied thanks to the requirements on (i) archetype component reference-domain finite element approximations, in particular related to a (common) fiducial port mesh, and (ii) connection pairs, in particular related to geometric compatibility. In fact, the dimension of X_{LIN}^{h}(μ′), [symbol] _{LIN}^{h}(μ′), is simply Σₗ₌₁ⁿ^{^{inst}}^{(μ′)} [symbol] _{bub}^{h;α(μ′,l)}+n^{glob}(μ′) [symbol] ^{h}.

We can now also be more precise in our definition of a(w, ν; μ′) in particular related to the parameter dependence implicit in (1). By construction,

$$a ( w , v ; {μ}^{′} ) ≡ {\sum }_{l = 1}^{{n}^{inst} ( μ′ )} {{\hat{a}}_{v ( μ′ , l )}^{α ( μ′ , l )} ( ( {( {v ( μ′ , l}_{rot α ( μ′ , l )}^{} )}^{- 1} w ) \vert}_{{D}_{v ( μ′ , l )}^{α ( μ′ , l )}} \cdot {v ( μ′ , l )}_{α ( μ′ , l )}^{} , ( ( \qquad \qquad ( 6 )$$

Note that we invoke only the archetype component reference-domain bilinear form. We may view (6) as an abstract form of direct stiffness summation applied at the component level. A similar construction exists for the synthesis of f (ν; μ′) of (1) from the linear forms associated to our archetype components.

We may now state our finite element approximation to (2): Given model parameter μ′∈ [symbol] ′, find u_{LIN}^{h}(μ′)∈X_{LIN}^{h}(μ′) such that

a(u_{LIN}^{h}(μ′), ν_{LIN}; μ′)−f(ν_{LIN}; μ′)=0, ∀ν_{LIN}∈X_{LIN}^{h}(μ′). (7)

This underlying finite element approximation shall serve as the foundation on which we build our PR-SCRBE-FE approximation (and hence contributes the FE part of the acronym). We will thus ultimately need to confirm both that our PR-SCRBE-FE approximation is sufficiently close to u_{LIN}^{h}(μ′) and that u_{LIN}^{h}(μ′) is indeed sufficiently close to u_{LIN}(μ′) . We now perform static condensation to obtain a bubble-eliminated finite element space,

Y^{h}(μ′)=span{Φₘ^{h}(μ′), 1≤m≤J^{h}(μ′)}, (8)

where J^{h}(μ′)≡n^{glob}(μ′) [symbol] ^{h} is the total number of (global) port degrees of freedom associated with our finite element approximation. Note each function Φ_{.}^{h} is associated to a particular global port, say Γₖ, shared by two instantiated components, say l and l′, and a particular fiducial port mode, say χⱼ^{j;fid}: Φ_{.}^{h} replicates χⱼ^{h;fid} (appropriately mapped) on Γₖ, vanishes at all ports other than Γₖ, is non-zero only over instantiated components l and l′, and satisfies the finite element equations for all bubble test functions in instantiated components l and l′. We may then write our finite element approximation, for given μ′∈ [symbol] ′, as

u_{LIN}^{h}(μ′)=u_{LIN}^{h;hom}(μ′)+u_{LIN}^{h;inhom}(μ′), (9)

for u_{LIN}^{h;hom}(μ′)∈Y^{h}(μ′) solution of

a(u_{LIN}^{h;hom}(μ′), ν; μ′)−(f(ν; μ′)−a(u_{LIN}^{h;hom}(μ′), ν; μ′))=0, ∀ν∈Y^{h}(μ′). (10)

Here u_{LIN}^{h;inhom}(μ′), which comprises a bubble function for each instantiated component, addresses inhomogeneities (loads) interior to the components; u_{LIN}^{h;inhom}(μ) may be calculated independently on each instantiated component, and thus poses little computational difficulty.

To arrive at the algebraic representation we insert the expansion

u_{LIN}^{h;hom}(μ′)=Σ_{m′=1}^{J}^{^{h}}^{(μ)}U_{LIN m′}^{h}(μ′)Φ_{m′}^{h}(μ′) (11)

into (10) and test on Φₘ^{h}(μ′), 1≤m≤J^{h}(μ′), to obtain our (statically condensed) linear system of equations: Given μ′∈ [symbol] ′, find U_{LIN}^{h}(μ′)∈ [symbol] ^{J}^{^{h}}^{(μ′)} solution of

S_{LIN}^{h}(μ′)U_{LIN}^{h}(μ′)=F_{LIN}^{h}(μ′). (12)

Here S_{LIN}^{h}(μ′)∈ [symbol] ^{J}^{^{h}}^{(μ′)×J}^{^{h}}^{(μ′)} is given by

(S_{LIN}^{h}(μ′))_{mm′}=a(Φ_{m′}^{h}(μ′), Φₘ^{h}(μ′); μ′), 1≤m,m′≤J^{h}(μ′)l (13)

the matrix S_{LIN}^{h}(μ′) is denoted the Schur complement. The vector F_{LIN}^{h}(μ′)∈ [symbol] ^{J}^{^{h}}^{(μ′)} may be expressed in terms of f, a, the ^{h}, and (known) u_{LIN}^{h;inhom}(μ). Note that linearity—a requirement for the static condensation procedure—ensures that the sum (11) satisfies the finite element equations for all bubble test functions in all instantiated components.

To motivate the model reduction, we note two computational difficulties associated with the classical Static Condensation approach. First, the number of finite element degrees of freedom on the ports, [symbol] ^{h}, will be large, resulting in a Schur complement with a large— [symbol] ^{h}×2 [symbol] ^{h}—dense block for each instantiated component in the system. Thus the solution of the Schur complement system (12) will be costly. Second, the calculation of each of the J^{h}(μ′)=n^{inst}(μ) [symbol] ^{h} functions Φ_{.}^{h}—which recall satisfy the finite element equations for bubble test functions in instantiated components l and l′—will be expensive: solution of two (sparse) linear systems of size [symbol] _{bub}^{h;α(μ′,l)}× [symbol] _{bub}^{h;α(μ′,l)} and [symbol] _{bub}^{h;α(μ′,l′)}× [symbol] _{bub}^{h;α(μ′,l′)}, respectively. Thus the formation of the Schur complement will be costly.

There are two aspects to the model order reduction: port reduction (PR)—we retain just the first M port modes, for M« [symbol] ^{h}; reduced basis (RB), or bubble, reduction—we replace, for 1≤α≤n^{arch}(μ′) archetype component (bubble) finite element space \hat{X}_{bub}^{h;α} of dimension [symbol] _{bub}^{h;α} with 2M+1 reduced basis approximation spaces—a tailored space for each port and each port mode as well as any interior load—of (maximum) dimension N^{α}, with N^{α}« [symbol] _{bub}^{h;aα}. Of course our simple truncation of port modes presumes that the port modes are ordered in an appropriate hierarchical fashion.

We may then propose the reduced bubble-eliminated space

Y^{h,M,N}(μ′)=span{Φₘ^{h,M,N}(μ), 1≤m≤J^{M}(μ′)}, (14)

where J^{M}(μ′)=n^{glob}(μ′)M, note h refers to the underlying finite element approximation space, M refers to the number of port modes retained, and N refers to the reduced basis approximation of Φ_{.}^{h}. We may then write our PR-SCRBE-FE approximation, for given μ′∈ [symbol] ′, as

u_{LIN}^{h,M,N}(μ′)=u_{LIN}^{h,M,N,hom}(μ′)+u_{LIN}^{h,M,N,inhom}(μ′), (15)

for u_{LIN}^{h,M,N;hom}(μ′)∈Y^{h,M,N}(μ′) solution of

a(u_{LIN}^{h,M,N;hom}(μ′), ν;μ′)−(f(ν;μ′)−a(u_{LIN}^{inhom}(μ′), ν; μ′))=0, ∀ν∈Y^{h,M,N}(μ′). (16)

Here u_{LIN}^{h,M,N;inhom}(μ′) is the reduced basis approximation of u_{LIN}^{h,M,N;inhom}(μ′); the former, just as the latter, may be calculated independently on each instantiated component. The approximation (16) will enjoy the usual optimality properties associated with Galerkin projection. (In actual fact, a Petrov-Galerkin (slight) variant of the Galerkin procedure described here can offer substantial computational advantages; the latter is thus typically pursued in practice. Our heterogeneous formulation of the next section requires no modification to accommodate the Petrov-Galerkin variant.)

We now proceed to the linear algebraic representation. In particular, we insert the expansion

u_{LIN}^{h,M,N;hom}(μ′)=Σ_{m′=1}^{J}^{^{M}}U_{LIN m′}^{h,M,N}(μ′)Φ_{m′}^{h,M,N}(μ′) (17)

into (16) and test on Φₘ^{h,M,N,}(μ′),1,≤m≤J^{M}(μ′), to obtain the PR-SCRBE-FE system: Given μ′∈ [symbol] ′, find U_{LIN}^{h,M,N}(μ′)ååå∈ [symbol] ^{J}^{^{M}}^{(μ′)} solution of

S_{LIN}^{h,M,N}(μ′)U_{LIN}^{h,M,N}(μ′)=F_{LIN}^{h,M,N}(μ′), (18)

where S_{LIN}^{h,M,N}(μ′)∈ [symbol] ^{J}^{^{M}}^{(μ′)×J}^{^{M}}^{(μ′)}, the reduced Schur complement, is given by

(S_{LIN}^{h,M,N}(μ′))_{mm′}=a(Φ_{m′}^{h,M,N}(μ′), Φₘ^{h,M,N}(μ′); μ′), 1≤m,m′≤J^{M}(μ′). (19)

The vector F_{LIN}^{h}(μ′)∈ [symbol] ^{J}^{^{M}}^{(μ′)} may be expressed in terms of f, a, the Φ_{.}^{h,M,N}, and (known) u_{LIN}^{h,M,N,inhom}.

Let us assume, optimistically, that M« [symbol] ^{h} and N^{α}« [symbol] _{bub}^{h,α}, 1≤α≤n^{arch}. In that case we successfully address the two computational challenges associated with Static Condensation. The first computational issue—number of port modes [symbol] ^{h}—is addressed by truncation of our port mode expansion in M« [symbol] ^{h} terms: the “PR.” The reduction [symbol] ^{h}→M decreases the cost to form the Schur complement and the cost to solve the Schur complement: S_{LIN}^{j}(μ), which is block-sparse n^{glob}(μ′) [symbol] ^{h}×n^{glob}(μ′) [symbol] ^{h}, is replaced by S_{LIN}^{h,M,N}(μ), which is block-sparse n^{glob}(μ′)M×n^{glob}(μ′)M. The second computational issue—the cost of the bubble contributions—is addressed by the reduced basis approximation: the “RB.” The reduction [symbol] _{bub}^{h;α}→N^{α} decreases the cost to form the Schur complement: the (sparse) [symbol] _{bub}^{h,α}× [symbol] _{bub}^{h, α} FE matrices required to calculate Φ_{.}^{h} are replaced by the (dense) N^{α}×N^{α} matrices —henceforth “RB matrices”—required to calculate Φ_{.}^{h,M,N}.

We must now justify our optimism as regards the reduction in the number of bubble and port degrees of freedom. In fact, the PR-SCRBE-FE bubble reduction is a standard extension of single-component reduced basis best practices, which furthermore requires no modification for the heterogeneous formulation as described herein; we emphasize here only that the training of the reduced basis (bubble) spaces may proceed independently on each archetype component and furthermore without reference to any particular system/model. On the other hand, the PR-SCRBE-FE port reduction must be adjusted to accommodate the heterogeneous formulation described herein. We thus briefly describe the standard PR-SCRBE-FE port training procedures.

It is well known, from simple separation-of-variable arguments, that (for elliptic partial differential equations) higher-wavenumber profiles over a cross-section will decay exponentially rapidly in the direction normal to the cross-section; in acoustics, the phenomenon is known as “evanescence”. This then provides the motivation, or justification, for port reduction: even if within instantiated components many higher modes may be (locally) excited by geometric variations, these evanescent modes will largely decay before reaching the corresponding instantiated ports. (We thus also identify an archetype component design best practice: to the extent possible, we should separate ports from regions of rapid or discontinuous geometric or property variation.)

There are several options for the identification of optimal port modes in the context of parametrized partial differential equations. All follow a similar procedure: define training systems of instantiated components; collect data (traces) on training system instantiated ports; map instantiated port data to parent fiducial port; apply POD to obtain fiducial port modes χⱼ^{h;fid}, 1≤j≤M. Note for the training systems we can identify “trainee” ports—on which we collect the data to be reduced—and “trainer” ports—on which we impose representative (say) Dirichlet data.

As described herein, we may exercise variants of two port training procedures. Method I: the training systems corresponds to models (or parts of models) of interest—each typically with many trainee ports—for (i) plausible Dirichlet data on trainer ports, and (ii) some large sample of model parameters. This approach is general, readily implemented, easily extended to a wide variety of problems, and often yields a small (but sufficient) number of port modes, M. However, the method requires construction and evaluation of potentially very large systems, the port modes identified are only reliable for the particular models sampled, and furthermore there is no theory for convergence. Method II: the training systems correspond to two-component systems instantiated from all possible pairs of archetype components in a given library for (i) optimal Dirichlet data on trainer ports, as identified by a transfer eigenproblem, and (ii) some large sample of component parameters. This method does not require the construction or evaluation of any (large) models, yet nevertheless provides port spaces relevant to a large family of (possible) models; furthermore, the method is supported by a theoretical framework, and in certain instances yields provably optimal port spaces. However, the training procedure is expensive, and the number of port modes can be excessive for a library with many archetype components.

We now turn to the PR-SCRBE-FE computational procedures. There are two stages to the PR-SCRBE-FE approach, an offline stage, and an online stage. In the offline stage we (i) train the port modes and reduced basis bubble functions, and (ii) store, in an Online Dataset, parameter-independent finite element inner products required to form the entries of the RB matrices and also the reduced Schur complement S_{LIN}^{h,M,N}(μ′). Note the latter requires an affine-in-parameter expansion of the bilinear and linear forms, typically effected (for nontrivial geometric variations) by the Empirical Interpolation Method, or EIM. In the online stage, given a particular model and model parameter μ′, we invoke the Online Dataset to form and solve the reduced Schur complement system, (18); the latter is typically effected by direct techniques—recall that the reduced Schur complement is small and block sparse. The essential point is that the operation count (and storage) of the online stage, apart from any field visualization, is independent of the resolution of the underlying truth finite element approximation, [symbol] _{LIN}^{h}(μ′).

Finally, we comment on the important role of components. First, as regards parametrization, we reduce a single large problem—the full model—with many parameters to many small problems with just a few parameters; we thus address, by divide and conquer, the curse of dimensionality which often plagues reduced basis techniques. Second, in the offline stage (at least for port training Method I), we solve finite element problems only over pairs of archetype components or single archetype components; we rarely solve—except in final verification studies—finite element problems associated with potentially very large systems. Third, we may amortize our offline effort not just over many queries (for different model parameter values) to a particular model, but also over all models which we may synthesize from our library of archetype components; we can thus tolerate higher offline costs. Fourth, we facilitate the development of new models: a common impediment to model order reduction without components is the relative inflexibility imposed by a priori specification of a particular model parameter domain, and the upfront “undiversified” risk associated with substantial offline investment for a single problem; both issues are mitigated by a component strategy.

Therefore, in some embodiments, the methods and systems described above provide a port-reduced, static-condensation reduced-basis element, finite element (PR-SCRBE-FE) approach. In one embodiment, methods and systems providing functionality for executing a method according to the PR-SCRBE-FE approach include functionality for performing the following: component-to-system synthesis, formulated as a Static-Condensation (SC) procedure; model order reduction, informed by evanescence arguments at component interfaces (port reduction by spectral truncation) and low-dimensional parametric manifolds in component interiors (bubble reduction by RB approximation); and offline-online computational decomposition strategies based on affine or approximate affine expansions in parameter. In some embodiments, both the offline and online stages benefit from parallel implementation (parallel computation can also effectively serve in the single-domain RB context). The PR-SCRBE-FE approach addresses the three single-domain RB shortcomings: (online) changes in topology are readily accommodated through component instantiation and connection; both bubble and port training procedures are typically performed on one-component and two-component systems, and hence the system avoids large FE calculations even in the offline stage; many applications are characterized by spatially distributed parameters, and hence the number of parameters associated with any given component is relatively small—divide and conquer. The PR-SCRBE-FE method may be viewed as a combination of the Component Model Synthesis (CMS) method (e.g., the method described above), and a reduced basis method: the CMS method provides the foundation of components, systems, and port and bubble reduction; the RB method provides the framework for efficient parametric analysis. The PR-SCRBE-FE method may thus be interpreted as an RBE method for the choice of Static Condensation (SC) interface treatment and strategies for port training, and bubble training.

Although the PR-SCRBE-FE method described above, and the static condensation elimination of component-interior degrees of freedom in particular, is typically limited to linear problems, the methods and systems describe herein may also incorporate the PR-SCRBE-FE method into non-linear analyses, which may be referred to as PR-SCRBE-FE/FE. The methods and systems described herein may be used to address a class of problems in which the spatial domain Ω can be decomposed as Ω̅=Ω̅_{LIN}∪Ω̅_{NLIN} such that the field is acted upon by a linear operator over Ω_{LIN}—e.g., linear elasticity—and a nonlinear operator over Ω_{NLIN}—e.g., contact or plasticity. The linear-nonlinear domain decomposition now admits a heterogeneous, or hybrid, formulation: a “linear” PR-SCRBE-FE approximation over Ω_{LIN} and a “nonlinear” approximation (more precisely, an approximation suitable for nonlinear operators) over Ω_{NLIN}. The methods and systems described herein also address local nonlinearities, for which the linear region Ω_{LIN} is as large as, and preferably substantially larger than, the nonlinear region Ω_{NLIN}; “linear predominance” is often realistic for contact and plasticity, in particular for structures in service (though not necessarily for forming processes).

There are (at least) two choices for the nonlinear approximation: reduced basis methods and full FE approximation in Ω_{NLIN}. Reduced basis methods are well developed for quadratic nonlinearities but can also treat higher-order smooth nonlinearities. Reduced basis methods can also accommodate non-smooth nonlinearities associated with variational inequalities and in particular contact problems. In some embodiments, given an assumption of linear predominance, the systems and methods described herein apply a full FE approximation in Ω_{NLIN}. In one of these embodiments, the decision between reduced basis methods and full FE approximation is motivated by ease of implementation and generality (as regards the form of the local nonlinearity), and justified by the requirement—to be confirmed on a case-by-case basis—that the nonlinearity acts over only a relatively small region of the domain (e.g., the number of degrees of freedom associated with the truth FE approximation over Ω_{LIN} should be larger than, and ideally much larger than, the number of degrees of freedom associated with the FE approximation over Ω_{NLIN}). Thus, this hybrid approximation may be referred to as PR-SCRBE-FE/FE, in which the first “FE” refers to the underlying “truth” finite element approximation on which we build the PR-SCRBE reduced order model over Ω_{LIN}(μ), and the second “FE” refers to the full finite element approximation over Ω_{NLIN}(μ).

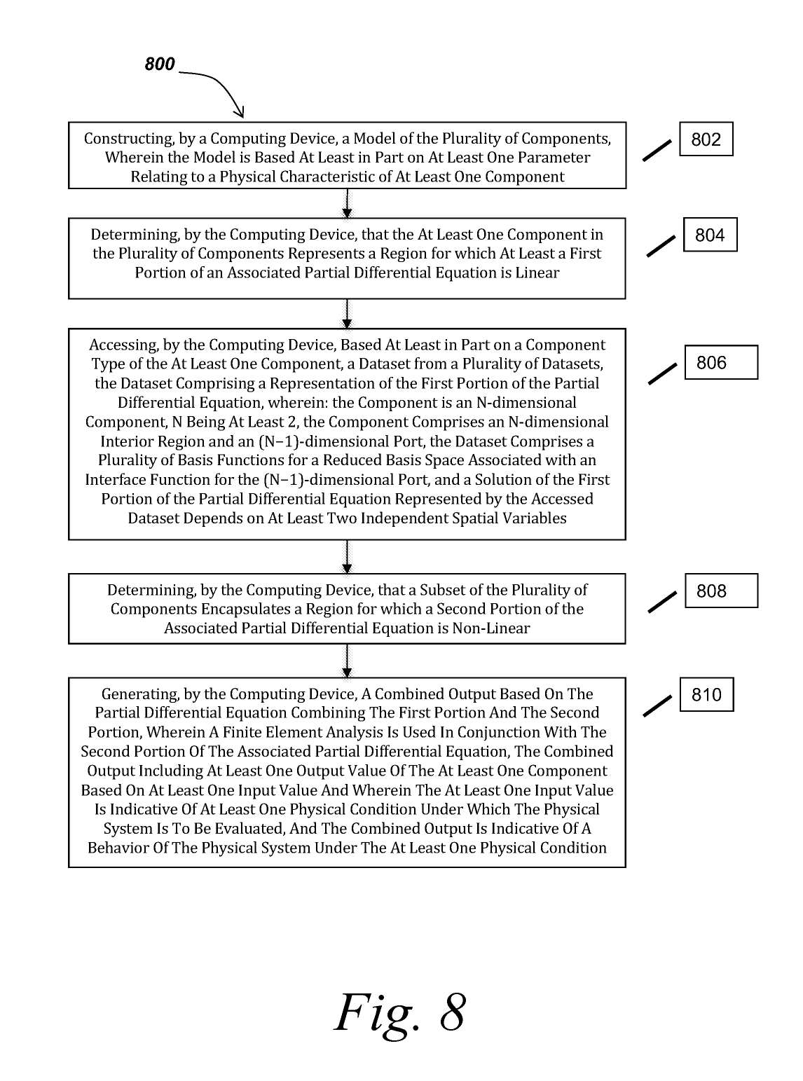

Referring now to FIG. 8, and in connection with FIGS. 1-7, a flow diagram depicts one embodiment of a method 800 for modeling and analyzing a physical system comprising a plurality of components. In brief overview, the method 800 includes constructing, by a computing device, a model of the plurality of components, wherein the model is based at least in part on at least one parameter relating to a physical characteristic of at least one component (802). The method 800 includes determining, by the computing device, that the at least one component in the plurality of components represents a region for which at least a first portion of an associated partial differential equation is linear (804). The method 800 includes accessing, by the computing device, based at least in part on a component type of the at least one component, a dataset from a plurality of datasets, the dataset comprising a representation of the first portion of the partial differential equation, wherein: the component is an N-dimensional component, N being at least 2, the component comprises an N-dimensional interior region and an (N−1)-dimensional port, the dataset comprises a plurality of basis functions for a reduced basis space associated with an interface function for the (N−1)-dimensional port, and a solution of the first portion of the partial differential equation represented by the accessed dataset depends on at least two independent spatial variables (806). The method 800 includes determining, by the computing device, that a subset of the plurality of components encapsulates a region for which a second portion of the associated partial differential equation is non-linear (808). The method 800 includes generating, by the computing device, a combined output based on the partial differential equation combining the first portion and the second portion, wherein a finite element analysis is used in conjunction with the second portion of the associated partial differential equation, the combined output including at least one output value of the at least one component based on at least one input value and wherein the at least one input value is indicative of at least one physical condition under which the physical system is to be evaluated, and the combined output is indicative of a behavior of the physical system under the at least one physical condition (810).

Referring now to FIG. 800 in greater detail, the method 800 includes constructing, by a computing device, a model of the plurality of components, wherein the model is based at least in part on at least one parameter relating to a physical characteristic of at least one component (802). In some embodiments, the simulation tool 104 constructs the model as described above in connection with FIGS. 1-7.

The method 800 includes determining, by the computing device, that the at least one component in the plurality of components represents a region for which at least a first portion of an associated partial differential equation is linear (804). In one embodiment, a user of the computing device 102 provides input via the user interface 106. In another embodiment, the simulation tool 104 analyzes the input to determine that the at least one component in the plurality of components represents the region for which at least a first portion of the associated partial differential equation is linear. As above, the user may pick a component and specify parameters of the component, identifying the component and any parameters via the user interface 106.

The method 800 includes accessing, by the computing device, based at least in part on a component type of the at least one component, a dataset from a plurality of datasets, the dataset comprising a representation of the first portion of the partial differential equation, wherein: the component is an N-dimensional component, N being at least 2, the component comprises an N-dimensional interior region and an (N−1)-dimensional port, the dataset comprises a plurality of basis functions for a reduced basis space associated with an interface function for the (N−1)-dimensional port, and a solution of the first portion of the partial differential equation represented by the accessed dataset depends on at least two independent spatial variables (806). In some embodiment, the simulation tool 104 accesses the dataset as described above in connection with FIGS. 1-7.

The method 800 includes determining, by the computing device, that a subset of the plurality of components encapsulates a region for which a second portion of the associated partial differential equation is non-linear (808). In one embodiment, a user of the computing device 102 provides input via the user interface 106. In another embodiment, the simulation 104 analyzes the input to determine that the subset of the plurality of components encapsulate a region for which the second portion of the associated partial differential equation is non-linear. In some embodiments, the user interface 106 may include functionality for flagging a potentially non-linear component for user review and receives user input regarding whether the component is linear or nonlinear. By way of example, the system may determine a point of contact between two linear regions or between a linear and a non-linear region and determine that a user should review the components modeled at the point of contact to determine which of the regions associated with those components, if any, should be treated as non-linear. As another example, the system may analyze one or more stresses and identify a region where the stress is beyond the material yield stress, so that plasticity analysis should be used in that region.

The method 800 includes generating, by the computing device, a combined output based on the partial differential equation combining the first portion and the second portion, wherein a finite element analysis is used in conjunction with the second portion of the associated partial differential equation, the combined output including at least one output value of the at least one component based on at least one input value and wherein the at least one input value is indicative of at least one physical condition under which the physical system is to be evaluated, and the combined output is indicative of a behavior of the physical system under the at least one physical condition (810). In some embodiments, a partial differential equation that combines both the first portion and the second portion (corresponding to linear and non-linear regions, respectively) provides the functionality needed to model both linear and non-linear regions of a physical system. In one of these embodiments, and as will be described in greater detail below, the use of a constraint matrix imposes the coupling between the linear and non-linear region and ensures compatibility of the two different types of regions. The partial differential equation is then solved as a single nonlinear system using, for example, Newton's method. This requires computation of the residual and Jacobian for the nonlinear system, which is achieved by first assembling the linear (PR-SCRBE-FE) and nonlinear (FE) parts separately, and then combining them into a single globally conforming system via the constraint matrix.

In some embodiments, the simulation tool 104 determines that the at least one component in the plurality of components includes a linear portion (804) and determines that the subset of the plurality of components encapsulate a region including a non-linear portion (808) and then accesses the dataset to construct the model of the plurality of components (802) before generating the combined output 810).

In some embodiments, by allowing users to specify which regions of a physical system being modeled are linear and which are non-linear, and by applying FE analyses to the non-linear regions, the methods and systems described herein provide a system that makes the determination to judiciously apply FE analysis when appropriate (e.g., to non-linear regions) and also providing the benefits of the PR-SCRBE-FE method, even if the entire physical system cannot actually be modeled using the PR-SCRBE-FE method. Unlike conventional approaches that rely upon full FE analyses or full PR-SCRBE-FE analysis, the methods and systems described herein provide a seamless link between the use of FE analysis and PR-SCRBE-FE analysis. Unlike conventional approaches that are typically computationally prohibitive to perform, use of the methods and systems described herein improve conventional technology for modeling physical systems by executing systems for selectively applying FE analysis to non-linear regions in combination with PR-SCRBE-FE analysis of linear regions. Conventional approaches typically fail to identify a method for coupling both types of analyses (PR-SCRBE-FE and FE) and therefore such approaches fail to solve the technical problem of solving a computationally expensive analysis with available computer resources. Nor do such conventionally provide users with the perception of providing a full FE analysis while providing functionality that allows users to understand and specify tolerance levels for computational errors. As a result, a computing device programmed to execute instructions for determining whether and how to combine both PR-SCRBE-FE and FE analysis is an improved machine providing a technical solution to a problem rooted in computer technology.

We note that in engineering practice it is common to develop a localized model of a high-stress region (such as a plasticity region), and to impose boundary conditions on the localized region to represent the effect of the larger structure. This workflow recognizes that conventional FE high fidelity models are typically very computationally intensive and can thus be invoked only sparingly. Therefore, the PR-SCRBE-FE/FE approach offers an efficient alternative for analysis of large-scale structures, and in particular overcomes the main drawback—unidirectional coupling—of the conventional localized modeling workflow.

In some embodiments, implementation of the PR-SCRBE-FE method is based on pre-trained components, which is what gives the speedup in the linear regions, and hence when a system leverages a PR-SCRBE-FE/FE solve, the system benefits from the pre-trained data; the pre-training is a computationally expensive procedure that relies on “training” a model for each PR-SCBRE-FE component in advance of the solving process; such a system provides technical resources and computational abilities beyond what can be accomplished manually.

Following below are detailed mathematical formulations for the hybrid of a static condensation reduced basis element method combined with a finite element analysis n combination with finite element analysis of non-linear regions of a physical system, as described above and in accordance with some embodiments of the present disclosure. It should be appreciated that such examples of specific implementations and applications are provided solely for purposes of illustration, and that the various inventive concepts presented herein are not limited to any particular implementation or application, as other implementations and applications may also be suitable.

In one embodiment, the simulation tool 104 defines a model parameter P-tuple μ in parameter domain [symbol] ⊂ [symbol] ^{P} and introduces a parametrized model spatial domain Ω(μ)⊂ [symbol] ³ with (non-empty) Dirichlet boundary ∂Ω_{D}(μ). The simulation tool 104 then decomposes Ω(μ) into two open subdomains Ω_{LIN}(μ) and Ω_{NLIN}(μ) such that

Ω̅_{LIN}(μ)∪Ω̅_{NLIN}(μ)=Ω̅(μ), Ω_{LIN}(μ∩Ω_{NLIN}(μ)=0. (20)

The simulation tool 104 further defines the interface between the two subdomains as

Γ_{INT}(μ)≡Ω̅_{LIN}(μ)∩Ω̅_{LIN}(μ). (21)

We shall assume that ∂Ω_{D}(μ) is the union of disjoint ∂Ω_{LIN,D}(μ) and ∂Ω_{NLIN,D}(μ); we further assume, for simplicity of exposition, that all Dirichlet (displacement) conditions are homogeneous, and that furthermore the Dirichlet boundaries are disjoint from Γ_{INT}. The subdomains Ω_{LIN}(μ) and Ω_{NLIN}(μ) are distinguished in two related ways: the field over Ω_{LIN}(μ) shall be acted upon only by linear operators, and in particular the linear elasticity operator, whereas the field over Ω_{NLIN}(μ) may be acted upon by nonlinear operators; the field over Ω_{LIN}(μ) shall be represented by a PR-SCRBE-FE approximation (fundamentally restricted to linear models), whereas the field over Ω_{NLIN}(μ) shall be represented by a full finite element approximation. In what follows, for any function w defined over Ω(μ), w_{LIN} (respectively, w_{NLIN}) shall refer to the restriction of w to Ω_{LIN}(μ), w|_{Ω}_{_{LIN}}_{(μ)} (respectively, the restriction of w to Ω_{NLIN}(μ), w|_{Ω}_{_{NLIN}}_{(μ)}).

We introduce the space X_{LIN}(μ)≡{ν∈(H¹(Ω_{LIN}(μ)))³|ν|_{∂Ω}_{_{LIN,D}}=0} and also the space X_{NLIN}(μ) ≡{ν∈(H¹(Ω_{NLIN}(μ)))³|ν|_{∂Ω}_{_{NLIN,D}}=0}. We may then define the space over Ω(μ) as X(μ)≡{ν∈(H¹(Ω(μ)))³|ν_{LIN}∈X_{LIN}, ν_{LIN}∈X_{NLIN}}. We next introduce forms f(⋅; μ): X_{LIN}(μ)→ [symbol] , a(⋅,⋅; μ): X_{LIN}(μ)×X_{LIN}(μ)→ [symbol] , and g(⋅,⋅; μ): X_{NLIN}(μ)×X_{NLIN}(μ)→ [symbol] which are respectively linear, bilinear, and linear in the second argument; we shall also require the Gateaux derivative of g about w̅∈X_{NLIN}, which we represent by the bilinear form (w∈X_{NLIN}(μ), ν∈X_{NLIN}(μ))→dg(w, ν; w̅; μ). We may now state the weak form of our partial differential equation: Given μ∈ [symbol] , find u(μ)∈X(μ) such that

a(u_{LIN}(μ), ν_{LIN}; μ)−f(ν_{LIN}; μ)+g(u_{NLIN}, ν_{NLIN}; μ)=0, ∀ν∈X(μ). (22)

In some embodiments, the flux continuity conditions on the field on the interface Γ_{INT} are incorporated (weakly) directly into (22), in particular associated with test functions v which do not vanish on Γ_{INT}, per standard practice for conforming variational approximations. We shall suppose for our purposes here that, for the parameter domain prescribed, our forms satisfy the necessary continuity and stability conditions such that (22) admits a unique solution. In fact, our approach can also be applied to problems with multiple solution branches and even bifurcations by appropriate enhancement of the PR-SCRBE-FE training procedures—to include behavior from different branches—and associated solution algorithms—to incorporate continuation information.

The linear model—the model over Ω_{LIN}(μ), corresponding to the first two terms in (22)—is the linear model considered in connection with FIGS. 1-9 above. The presence of the third (nonlinear) term in (22) serves, from the perspective of the linear model, solely to provide the appropriate inhomogeneous Neumann term. (The latter, of course, only emerges from the solution of the coupled linear-nonlinear model.) Although our linear model is typically universal across problems, the nonlinear model—the model over Ω_{NLIN}(μ)—will vary from problem to problem. The weak form g will be specified in the context of each family of nonlinearities considered.

In general, the interface conditions are treated as constraints which may be imposed either through Lagrange multipliers and penalty terms or by explicit elimination. In one embodiment, the simulation tool 104 conforms approximations and explicit constraint elimination, both facilitated by the fiducial port structure associated with the (conforming) PR-SCRBE-FE method.

The simulation tool 104 may directly apply the PR-SCRBE-FE formulation to the linear model, as described above in connection with FIGS. 1-7. In one embodiment, the PR-SCRBE-FE approximation is constructed such that Γ_{INT} corresponds to a single global port, which for convenience, and without loss of generality, we choose as Γ₁. We shall further assume that Γ₁ is independent of μ. (In some embodiments, however, Γ_{INT} may correspond to any number of global ports, all of which may be parameter-dependent.) We choose our enumeration of components and ports to ensure that global port Γ₁ corresponds to instantiated port 1 of instantiated component 1 derived from archetype component 1. We further choose our index mapping such that the PR-SCRBE-FE degrees of freedom associated with Γ₁ correspond to the first M basis functions of Y^{h,M,N}(μ), Φₘ^{h,M,N}(μ), 1≤m≤M.

Before proceeding to the heterogeneous PR-SCRBE-FE/FE approximation we identify the global finite element approximation over Ω(μ). We recall that the component synthesis of the system associated to our model induces, for any given μ∈ [symbol] , an underlying “truth” finite element approximation, X_{LIN}^{h}(μ) of dimension [symbol] _{LIN}^{h}(μ). We next introduce the finite element space for the nonlinear model over Ω_{NLIN}(μ), X_{NLIN}^{h}(μ)⊂X_{NLIN}(μ) of dimension [symbol] _{NLIN}^{h}(μ). X_{LIN}^{h}(μ) and X_{LIN}^{h}(μ) shall strongly respect the interface Γ_{INT}(μ): for any ν₁∈X_{LIN}^{h}(μ) (respectively, for any ν₂∈X_{NLIN}^{h}(μ)) there exists a ν₂∈X_{NLIN}^{h}(μ) (respectively, a ν₁∈X_{LIN}^{h}(μ)) such that ν₁|_{Γ}_{_{INT}}_{(μ)}; the latter imposes a constraint on the meshes—coincident same-order element faces on Γ_{INT}—associated with X_{LIN}^{h}(μ) and X_{NLIN}^{h}(μ). We shall later discuss a particular strategy by which to enforce this constraint, in particular through fiducial ports. We shall also need the space X_{NLIN,0}^{h}(μ)≡{ν∈X_{NLIN}^{h}(μ)|ν|_{Γ}_{_{INT}}_{(μ)}=0}; X_{NLIN,0}^{h}(μ) is of dimension [symbol] _{NLIN,0}^{h}(μ)= [symbol] _{NLIN}^{h}(μ)− [symbol] ^{h} (given that Γ_{INT} is a single port). We then associate to X_{NLIN,0}^{h}(μ) and X-hd NLIN^{h}(μ) nodal bases {κᵢ(μ)}_{i=1, . . . ,} [symbol] _{_{NLIN,0}}_{^{h}} and {κᵢ(μ)}_{i=1, . . . ,} [symbol] _{_{NLIN}}_{^{h}}, respectively; note that, for convenience in the subsequent algebraic representation, we enumerate last the nodal degrees of freedom associated with X_{NLIN}^{h}(μ) on the interface, Γ_{INT}.

The global finite element space over Ω(μ), X^{h}(μ) of dimension [symbol] ^{h}(μ), is thus given by X^{h}(μ)≡{ν∈X(μ)|ν_{LIN}∈X_{LIN}^{h}(μ′), ν_{NLIN}∈X_{NLIN}^{h}(μ)}; under our assumptions on the constituent finite element spaces, [symbol] ^{h}(μ)= [symbol] _{LIN}^{h}(μ)+ [symbol] _{NLIN}^{h}(μ)= [symbol] ^{h}, where the last term corrects for the duplication of degrees of freedom on (the single-port interface) Γ_{INT}(μ). We can then state our underlying “truth” finite element approximation: Given μ∈ [symbol] , find u^{h}(μ)∈X^{h}(μ) such that

a(u_{LIN}^{h}(μ), ν_{LIN}; μ)−f(ν_{LIN}; μ)+g(u_{NLIN}, ν_{NLIN}; μ)=0, ∀ν∈X^{h}(μ). (23)

Such a PR-SCRBE-FE/FE approximation is built upon the global finite element approximation (23): X_{NLIN}^{h}(μ) is the finite element space for the full FE approximation over Ω_{NLIN}(μ); X_{LIN}^{h}(μ) is the underlying finite element space for the PR-SCRBE-FE approximation over Ω_{LIN}(μ); the PR-SCRBE-FE approximation should therefore be sufficiently close to u^{h}(μ), and u^{h}(μ) sufficiently close to u(μ). The global finite element approximation u^{h}(μ) will also serve as a reference with respect to which we can assess the computational cost of the PR-SCRBE-FE approach.

Regarding the PR-SCRBE-FE/FE heterogeneous approximation, the simulation tool 104 uses a PR-SCRBE-FE space over Ω_{LIN}(μ), Y^{h,M,N}(μ) of dimension J^{M}(μ). The heterogeneous approximation space is then given by X^{H}(μ)≡{ν∈X^{h}(μ)|ν_{LIN}∈Y^{h,M,N}(μ), ν_{NLIN}∈X_{NLIN}^{h}(μ)}; note that implicitly the degrees of freedom on the interface are dictated by Y^{y,M,N}(μ), since M≤ [symbol] ^{h}. The superscript H represents the several discretization parameters which characterize X^{H}(μ), including the finite element resolution in Ω_{LIN}(μ) and Ω_{NLIN}(μ) and also M and N^{α}, 1≤α≤n^{arch}(μ). The dimension of space X^{H}(μ) will be denoted [symbol] ^{H}(μ); it shall also prove convenient to define [symbol] ^{H,+}(μ)= [symbol] ^{H}(μ)+ [symbol] ^{h}, which includes the finite element “non-degrees of freedom” on Γ_{INT}.

We define our heterogeneous approximation as

u^{H}(μ)=U^{H;hom}(μ)+u_{LIN}^{h,M,N,inhom}(μ), (24)

for u_{LIN}^{h,M,N;inhom}(μ) (and extended by zero to the entire domain, ω(μ)). Given μ∈ [symbol] , u^{H;hom}(μ)∈X^{h}(μ) satisfies

a(u_{LIN}^{H;hom}(μ), ν_{LIN}; μ)−(f(ν_{LIN}; μ)−a(u_{LIN}^{h,M,N;inhom}(μ), ν_{LIN}; μ))−g(u_{NLIN}^{H;hom}(μ), ν_{NLIN}l μ)=0, ∀ν∈X^{H}(μ). (25)

Note that g may include inhomogeneous terms, e.g. loads within Ω_{NLIN}(μ). We shall focus attention on a formulation which preserves the decoupled nature of the heterogeneous approximation, in particular a strict decomposition into “non-invasive” linear and nonlinear contributions.

The simulation tool 104 defines liftings of the port functions on the interface, ξⱼ≡(χⱼ^{h;fid}∘(τ^{α=1, i=1})⁻¹)∘( [symbol] _{v(μ,l=1)}^{α=1})⁻¹, 1≤j≤M, over Ω_{NLIN}(μ): for j=1, . . . , m, [symbol] _{NLIN}ξⱼ is given by

$$( {ℒ}_{NLIN} {ξ}_{j} ) ( μ ) = {\sum }_{i = 1}^{{𝒩}_{NLIN}^{h} ( μ )} {ξ}_{i , j} ( μ ) {κ}_{i} ( μ ) , \qquad ( 26 )$$

for ξ_{i,j}(μ), 1≤i≤ [symbol] _{NLIN}^{h}(μ), chosen such that [symbol] _{NILI}ξⱼ|_{Γ}_{_{INT}}=ξⱼ; such a construction is perforce possible given our assumptions on the underlying finite element approximation. This results in construction of compatible versions of the port functions on the interface on the FE region. We note that a particularly simple, and also efficient, choice for the lifting coefficients is ξ_{i,j}=0, 1≤i≤ [symbol] _{NLIN,0}^{h}(μ); we consider that particular case in this paper. We then define a constraint, or prolongation, matrix C∈ [symbol] as

$${C}_{i , j} ≡ \{ \begin{matrix}{δ}_{i , j} & 1 \leq i , j \leq {𝒩}_{NLIN , 0}^{h} & ( 27 ) \text{-} a \\ {ξ}_{i , j - {𝒩}_{NLIN , 0}^{h}} & \begin{matrix}1 \leq i \leq {𝒩}_{NLIN}^{h} , {𝒩}_{NLIN , 0}^{h} + \\ 1 \leq j \leq {𝒩}_{NLIN , 0}^{h} + M\end{matrix} & , ( 27 ) \text{-} b \\ {δ}_{i - {ℳ}^{h} , j} & \begin{matrix}{𝒩}_{NLIN}^{h} + 1 \leq i \leq {𝒩}_{H}^{+} , {𝒩}_{NLIN , 0}^{h} + \\ 1 \leq j \leq {𝒩}_{H}\end{matrix} & ( 27 ) \text{-} c \\ 0 & otherwise & ( 27 ) \text{-} d\end{matrix}$$

where δ_{i,j} is the Kronecker-delta symbol. It is understood that C may depend on μ, even for ξⱼ, 1≤j≤M, independent of μ, since the approximation spaces and the dimensions of the approximation spaces may depend on μ. In the remainder of this section we continue to leave the latter implicit.

Regarding the action of C, given a basis-coefficient vector W^{H}∈ [symbol] , which we further decompose as W^{H}≡(W_{LIN}^{H},W_{NLIN}^{H}) for W_{LIN}^{H}∈ [symbol] ^{j}^{^{h,M}}, W_{NLIN}^{H}∈ [symbol] , we can express any member w∈X^{H} as

$$w = {\sum }_{m = 1}^{{𝒩}_{NLIN}^{h}} {( {CW}^{H} )}_{m} {κ}_{m} ( μ ) + {\sum }_{m = 1}^{{J}^{M}} {( {CW}^{H} )}_{{𝒩}_{NLIN}^{h} + m} {Φ}_{m}^{h , M , N} ( μ ) ; \qquad ( 28 )$$

here we interpret κ. (respectively, Φ_{.}^{h,M,}) outside Ω̅_{NLIN}(μ) (respectively, outside Ω̅_{LIN}(μ)) as zero. Note that w is continuous over Ω(μ), since the coefficients in the two sums in (28) are coupled—through C—to ensure a common representation over Γ_{INT}. In words, (27)—a directly “passes through” the coefficients of the interior degrees of freedom within Ω_{NLIN}; (27)—b impresses the trace (over Γ_{INT}) of the approximation over Ω_{LIN} onto the approximation over Ω_{NLIN}; and (27)—c directly passes through the coefficients of the degrees of freedom within Ω_{LIN}. As regards the latter, (27)—c constitutes a J^{M}×J^{M} identity block in the lower right corner of C, and thus we may also write

$$w = {\sum }_{m = 1}^{{𝒩}_{NLIN}^{h}} {( {CW}^{H} )}_{m} {κ}_{m} ( μ ) + {\sum }_{m = 1}^{{J}^{M}} {W}_{NLIN}^{H} {Φ}_{m}^{h , M , N} ( μ ) ; \qquad ( 29 )$$

we use the identity block for the transpose operation.

We introduce the basis-coefficient vector U^{H}(μ)∈ [symbol] terms of which we express u^{H;hom}(μ) through an expansion of the form (28); we further decompose U^{H}(μ) as (U_{LIN}^{H},U_{NLIN}^{H}) for U_{LIN}^{H}∈ [symbol] ^{J}^{^{M}}, U_{NLIN}^{H}∈ [symbol] _{NLIN,0}. In this way, we now solve to obtain a single solution vector which expresses the solution of the entire partial differential equation, including both the linear and nonlinear regions. We similarly introduce the basis-coefficient vector V^{H} in terms of which we express any test function ν∈X^{H}(μ) through an expansion of the form (28). We now insert our expansions for u^{H;hom}(μ) and ν into (25) to arrive at a discrete statement of our heterogeneous approximation: find U^{H}(μ)∈ [symbol] such that

C^{T}R^{H,+}(U^{H}(μ); μ)=0, (30)

where T denotes matrix transpose. Here the residual vector R^{H,+}∈ [symbol] is given by

$${R}^{H , +} ( {U}^{H} ( μ ) ; μ ) ≡ ( \begin{matrix}{G}_{NLIN}^{h} ( {U}^{H} ( μ ) ; μ ) \\ {S}_{LIN}^{h , M , N} ( μ ) {U}_{LIN}^{H} ( μ ) - {F}_{LIN}^{h , M , N} ( μ )\end{matrix} ) , \qquad ( 31 )$$

where, for any W^{H}∈ [symbol] , G_{NLIN}^{h}(W^{H}; μ)∈ [symbol] is given by

$${( {G}_{NLIN}^{h} ( {W}^{H} ; μ ) )}_{i} ≡ g ( {\sum }_{j = 1}^{{𝒩}_{NLIN}^{h}} {( {CW}^{H} )}_{j} {κ}_{j} , {κ}_{i} ; μ ) , 1 \leq i \leq {𝒩}_{NLIN}^{h} , \qquad ( 32 )$$

for S_{LIN}^{h,M,N}(μ) and F_{LIN}^{h,M,N}(μ). The residuals on Ω_{LIN}(μ) and Ω_{NLIN}(μ) are coupled through C^{T}, which imposes the necessary weak flux continuity condition through the Neumann operators on the respective domains.

The nonlinear contribution is restricted solely to Ω_{NLIN}(μ). We note from (31)-(32) that the residual may be calculated independently on each subdomain, Ω_{LIN}(μ) and Ω_{NLIN}(μ), and then connected very “sparsely” through the constraint matrix C; in particular, the residual over Ω_{LIN}(μ) is the standard Γ_{INT}-Neumann residual over Ω_{LIN}(μ), with no reference to (the nonlinearity on) Ω_{NLIN}(μ) . The advantages of the linear-nonlinear decomposition are well established in development of more efficient solution algorithms: static condensation—substructuring—may be performed on the linear part of the model only once, at the outset, rather than at each step of a nonlinear iteration (see, e.g., Ansys Manual, Advanced Analysis Techniques, http://www.ansys.stuba.sk/html/guide_55/g-adv/GADV5.htm). One benefit provided by an embodiment implementing the methods and systems described herein is efficient treatment of parametric variation: we take advantage of the linear-nonlinear decoupling to adapt, as regards both formulation and also implementation, the PR-SCRBE-FE approach—μ→S_{LIN}^{h,M,N}(μ)—to the linear-nonlinear heterogeneous framework; we may thus amortize the offline (sub structuring) effort not just over many queries to a single problem, but also over a very large family of problems (systems) associated to our library of archetype components. Enabling parametric variation in the nonlinear case is an improvement over systems that provide only the PR-SCRBE-FE methodology.

We shall solve our nonlinear system by Newton iteration, which thus requires both the residual as well as the Jacobian. We briefly describe here the representation of the Jacobian. We denote by W̅^{H}∈ [symbol] the basis vector associated with some member w̅ in X^{H}(μ) (in actual practice, the current iterate). The Jacobian [symbol] ^{H}(μ)∈ [symbol] × [symbol] can then be expressed as

$${H}^{} ( μ ) ≡ {C}^{T} \underbrace{( \begin{matrix}{dG}_{NLIN}^{h} ( {\overline{W}}^{H} ; μ ) & 0 \\ 0 & {S}_{LIN}^{h , M , N} ( μ )\end{matrix} )}_{{H , +}^{} ( μ )} C , \qquad ( 33 )$$

where dG_{NLIN}^{h}∈ [symbol] _{NLIN}^{h}× [symbol] _{NLIN}^{h} is given by

$$\begin{matrix}{( {dG}_{NLIN}^{h} ( {\overline{W}}^{H} ; μ ) )}_{i , j} ≡ d g ( {κ}_{j} , {κ}_{i} ; {\sum }_{k = 1}^{{𝒩}_{NLIN}^{h}} {( C {\overline{W}}^{H} )}_{k} {κ}_{k} ; μ ) , & ( 34 ) \\ 1 \leq i , j \leq {𝒩}_{NLIN}^{h} . & \end{matrix}$$

[symbol] ^{H,+}(μ)∈ [symbol] (or the action of [symbol] ^{H,+}(μ)) may be evaluated independently on Ω_{LIN}(μ) and Ω_{NLIN}(μ), and hence the only coupling between the two subdomains is through the very sparse constraint matrix C. Furthermore, the Jacobian on Ω_{LIN}(μ) is the standard Γ_{INT}-Neumann Jacobian—stiffness matrix—over Ω_{LIN}(μ), with no reference to (the nonlinearity) on Ω_{NLIN}(μ). Hence, as for the residual, the PR-SCRBE-FE formulation and implementation is effectively “ignorant” of the linear-nonlinear heterogeneous approximation to which it so courageously contributes.

Finally, we return to the motivation for the linear-nonlinear heterogeneous approximation: the size of our discrete system, and hence the cost of residual and Jacobian inversion, can be greatly reduced—from [symbol] ^{h} to [symbol] _{NLIN,0}^{h}+J^{M}—if the extent of the nonlinear domain is relatively small. In this regard, the sparsity associated with decoupled evaluation plays an important role.

The methods and systems described herein may provide a flexible framework for construction of a compatible finite element approximation over Ω_{NLIN}(μ) . The methods and systems described herein may also provide incorporation of the nonlinear model in the port training of the PR-SCRBE-FE approximation of the linear model. (We note that the reduced basis training is restricted to bubbles and thus by definition interior to Ω_{LIN}(μ)—hence affected by the nonlinear model only indirectly, through the port modes.)

Regarding the finite element preparations over Ω_{NLIN}(μ), there are many ways to proceed; in one embodiment, the simulation tool 104 uses a component approach which is directly compatible with the PR-SCRBE-FE formulation described above in connection with FIGS. 1-7. Of particular interest are dual-purpose components which can serve either within Ω_{NLIN}(μ) as part of the PR-SCRBE-FE approximation of the linear model or within Ω_{NLIN}(μ) as part of the FE approximation of the nonlinear model. In effect, we form and train the components for the linear regime. Then, if in any given model and in any particular instantiated component our linear criteria—no contact with other bodies, stress less than yield stress, etc.—are satisfied, we include the component in Ω_{LIN}(μ) and take advantage of the PR-SCRBE-FE acceleration; these components are denoted “PR-SCRBE-FE components.” If, however, the linear criteria are not satisfied, the instantiated component is assigned to Ω_{NLIN}(μ) and the corresponding (formerly, part of the underlying) finite element approximation is “stitched in” to X_{NLIN}^{h}(-82 ); these components are denoted “FE components.” This process can be effected dynamically, for example as part of a loading path, since all the necessary data is available in the Online Dataset. The assignment from linear to nonlinear can in some cases be reversed, for example in the context of elastic contact, but in other cases not, for example in the context of plasticity. In all cases the fiducial ports ensure easy integration and compatible linear-nonlinear approximations. We note that dual-purpose components are not always of interest, in particular in situations in which the behavior in a component is known a priori to be nonlinear.

We next consider the port training. We first note that a first approach, model training, requires no modification within the linear-nonlinear context. On the other hand, a second approach, transfer eigenproblem pairwise training, does rely on linearity. For the application of the second approach to the current linear-nonlinear context there are two possibilities. The first possibility is to simply apply the port modes generated in the linear regime also at the ports on Γ_{INT}. This optimistic approach is not without some justification: the nonlinear model presumably relaxes to linear form in the vicinity of Γ_{INT}; hence, the linear ports mode generated for the library might also be relevant on the Γ_{INT}. The second possibility is to include buffer linear components in Ω_{NLIN}(μ) which reside between the nonlinear components and Γ_{INT}. Then, the behavior on Γ_{INT} will perforce be included in the port modes since the linear components which Γ_{INT} divides will be included in the training procedure. This buffer approach is rigorous, however the method requires the incorporation of additional components in Ω_{NLIN}(μ), and hence more degrees of freedom in X_{NLIN}^{h}(μ) and commensurately higher computational cost.

In some embodiments, there are different examples of a nonlinear operator g(⋅,⋅; μ) on Ω_{NLIN}(μ). Note that to simplify notation below we introduce, for w,ν∈X_{NLIN}^{h}(μ), gₗᵢₙ(w, ν; μ)≡a(w, ν; μ) −f(ν; μ): here a and f are defined above in connection with FIGS. 1-9 but now for _{LIN} replaced by _{NLIN}; gₗᵢₙ(⋅,⋅; μ) thus refers to the linear elasticity forms but over Ω_{NLIN}(μ).

In one embodiment, the simulation tool 104 may use contact analysis as described by an augmented Lagrangian method, since this provides an advantageous combination of accuracy and efficiency. We emphasize, however, that the PR-SCRBE-FE/FE framework presented in this work would apply equally well to other contact formulations too.

In the case where Γ_{c}(μ) denotes a pair of contact surfaces in Ω_{NLIN}(μ), and for w,ν∈X_{NLIN}^{h}(μ) we set

g(w, ν; μ)≡gₗᵢₙ(w, ν; μ)+∫_{Γ}_{_{c}}_{(μ)(λ}^{k}(s)+ε_{N}h_{N}(s))nᵢ^{m}(s)νᵢ(s)ds, (35)

where h_{N} denotes the normal-direction “gap function,” ε_{N} is the normal-direction contact penalty, λ^{k} is the augmented Lagrangian parameter at step k and at s∈Γ_{c}, and n^{m}(s) is the normal direction on the master surface. h_{N} is defined as

h_{N}(s)≡(uᵢ^{m}(S) −uᵢ^{m}(s))nᵢ^{m}(s), (36)

where u^{m} (resp. u^{s}) is the displacement on the master (resp. slave) surface. This definition implies that h_{N}>0 if there is overlap, and h_{N}<0 if there is a gap. At each augmented Lagrangian iteration we solve the nonlinear system by Newton's method, and we then apply the standard first-order update formula for λ^{k}(s) for s∈Γ_{c},

$${λ}^{k + 1} ( s ) = ( \begin{matrix}{λ}^{k} ( s ) + {ɛ}_{N} {h}_{N} ( s ) , & if {λ}^{k} ( s ) + {ɛ}_{N} {h}_{N} ( s ) > 0 \\ 0 , & otherwise\end{matrix} . \qquad ( 37 )$$

In one embodiment of the implementation, we impose the augmented Lagrangian contact terms as nodal forces on Γ_{c}. It is often desirable to plot the contact pressure on Γ_{c}: the pressure can be reconstructed from the Lagrange multiplier-cum-nodal force at each node as p_{N}(s)=λ(s)/A_{nodal}(s), where A_{nodal}(s) is the area associated to the node at s. In one embodiment, we terminate the augmented Lagrangian updates once the maximum gap or overlap on Γ_{c} is below a pre-specified tolerance. Note that Γ_{c} in fact denotes a pair of potential contact surfaces and that, upon convergence, the actual contact surface is extracted as that part of Γ_{c} over which λ^{k} is non-zero.

Next we consider the addition of frictional terms to g based on the classical Coulomb model. In one embodiment, the method includes a tangential traction t_{T} on the contact surface Γ_{c}. This tangential traction imposes the stick/slip behavior that is characteristic of friction. In particular, we let μ_{fr} denote the coefficient of friction; then “stick” is obtained if ∥t_{T}∥≤μ_{fr}|p_{N}|, and “slip” is obtained otherwise. In the slip case, the tangential and normal stresses are related as ∥t_{T}∥=μ_{fr}|p_{N}|, where p_{N} is the normal contact pressure, and t_{T} is aligned in the direction opposite to that of the slip. To resolve numerical issues associated with the inherent discontinuity of the Coulomb model, we follow the well-established regularization approach based on the analogy between friction and plasticity: the stick regime is modeled as an elastic response; the slip regime is modeled as a perfectly plastic response. We combine the normal contact formulation from (35) and the frictional tangential traction described above to obtain, for w, ν⊂_{NLIN}^{h}(μ),

g(w, ν; μ)≡gₗᵢₙ(w, ν; μ)+∫_{Γ}_{_{c}}_{(μ)}[(λ^{k}(s)+ε_{N}h_{N}(s))nᵢ^{m}(s)+t_{T,i}(s)]νᵢ(s)ds. (38)

We apply the same augmented Lagrangian scheme with inner Newton loop as described above. The key difference in this embodiment is that we also update the tangential traction based on the regularized stick/slip formulation within each inner Newton iteration.

In some embodiments, the simulation tool 104 includes an implementation for addressing plasticity as follows. In this case we introduce, for w, ν∈X_{NLIN}^{h}(μ),

$$g ( w , v ; μ ) ≡ {\int }_{{Ω}_{NLIN} ( μ )} {( {σ}_{EP} ( w ) )}_{ij} \frac{\partial {v}_{i}}{\partial {x}_{j}} dx - f ( v ; μ ) , \qquad ( 39 )$$

where the “EP” subscript refers to “elastic-plastic,” and σ_{EP} is obtained from the radial return algorithm. Note that the linear elasticity model over Ω_{LIN}(μ) and g(⋅,⋅; μ) from (39) over Ω_{NLIN}(μ) are “compatible” in the sense that at the interface between the plastic and linear domains, Γ_{INT}, we correctly recover (weak) continuity of stress; in fact, Ω_{NLIN}(μ) is chosen such that g(⋅,⋅; μ) reduces to gₗᵢₙ(⋅,⋅; μ) in a neighborhood of Γ_{INT}. Other models (e.g. isotropic and kinematic hardening) could be accommodated via a radial return method. We utilize the “consistent elastoplastic tangent” when we apply Newton's method to this nonlinear system to ensure second-order convergence. We may also incorporate contact terms described above into (39), if desired, in order to model plasticity with contact.

Each region in a model that includes a contact surface and a both linear region and a nonlinear region involves a plurality of calculations. By way of example, and without limitation, a global finite element mesh of trilinear elements may include 124,370 nodes and hence 373,110 FE displacement degrees of freedom; applying Newton's method and solving for a solution of the Jacobian system might take a computing device include eight central processing unit cores approximately six minutes to calculate but applying the PR-SCRBE-FE methodologies described above might take the same computing device only one minute. As another example, in a scenario in which a global FE approximation includes 2,203,230 degrees of freedom, a regular FE analysis might take on the order of 40 minutes, while a PR-SCRBE-FE approach may take less than half of one minute, improving solution times by a factor of more than 92. As one of ordinary skill in the art would understand, those of ordinary skill cannot and do not regularly perform such steps in such time frames mentally or using pen and paper.

Some embodiments of the methods and systems described herein, therefore, provide a novel, non-obvious approach to combine component-based model reduction via the PR-SCRBE-FE formulation with conventional FE. This leads to a hybrid PR-SCRBE-FE/FE formulation which combines attractive features of both approximation methods: PR-SCRBE-FE brings the ability to develop fast parameterized models of large systems, and FE brings the ability to incorporate the full range of nonlinear physics. The formulation is fully conforming on the interface of the PR-SCRBE-FE and FE regions, which leads to a numerically robust method. Moreover, the formulation leads to a convenient implementation in which standard PR-SCRBE-FE and FE matrix and vector assembly routines can be fully reused. Implementations of the PR-SCRBE-FE/FE method may provide an attractive middle ground between the two extremes of global FE and global model reduction, and a set of capabilities that fit well with practical workflows that are required for industrial-scale engineering analysis.

While various illustrative features of a simulation tool are discussed above, should be appreciated that aspects of the present disclosure are not limited to any specific feature or combination of features. Nor are aspects of the present disclosure limited to the illustrative arrangement of modules shown in the figures. Rather, a simulation tool may, for example, include fewer modules, more modules, or different modules, and each module may perform any suitable functionality or combination of functionalities. Furthermore, the modules may be arranged in any suitable manner. For example, in some embodiments, one or more modules may be located remotely from other modules and the modules may communicate with each other using any suitable networking technologies. Further still, some of the computations performed by a module may be distributed across different computers, for example, to deliver simulation results in less time.

It should be appreciated that various concepts introduced above and discussed in greater detail below may be implemented in any of numerous ways, as the disclosed concepts are not limited to any particular manner of implementation. For instance, the present disclosure is not limited to the particular arrangements of components shown in the various figures, as other arrangements may also be suitable. Such examples of specific implementations and applications are provided solely for illustrative purposes.

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment.

The systems and methods described above may be implemented as a method, apparatus, or article of manufacture using programming and/or engineering techniques to produce improved software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc. Installation of the program or programs may be considered to modify the computing device into a special purpose machine for modeling and analyzing a physical system comprising a plurality of components through the use of the methods and systems described above.

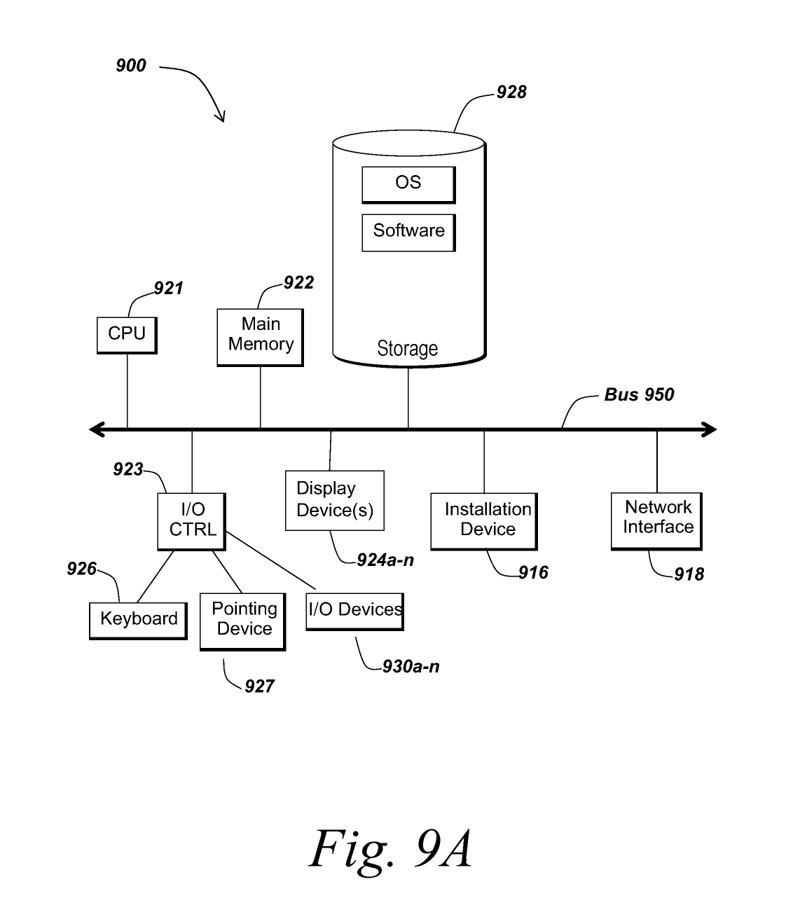

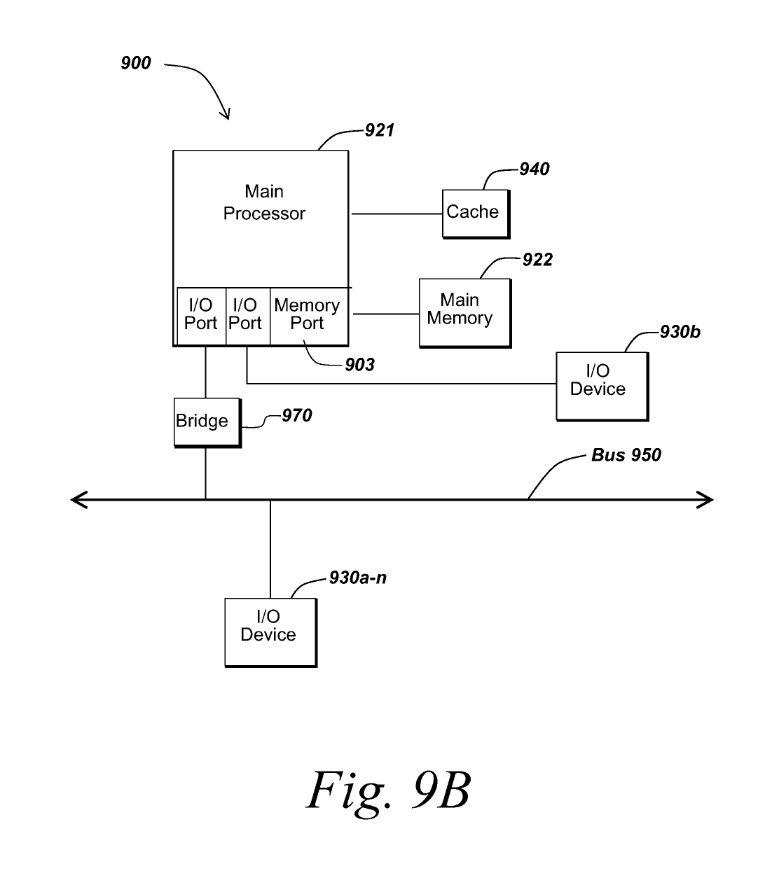

A computing device 102 can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that may be modified to create a new computing device that provides the functionality described above and that has sufficient processor power and memory capacity to perform the operations described herein. A computing device 102 may execute, operate or otherwise provide an application, which can be any type and/or form of software, program, or executable instructions, including, without limitation, any type and/or form of web browser, web-based client, client-server application, an ActiveX control, or a JAVA applet, or any other type and/or form of executable instructions capable of executing on a computing device 900 as described in connection with FIGS. 9A-B below.

FIGS. 9A and 9B depict block diagrams of a computing device 900 useful for modification in order to provide a computing device 102 having the functionality described above. As shown in FIGS. 9A and 9B, each computing device 900 includes a central processing unit 921, and a main memory unit 922. As shown in FIG. 9A, a computing device 900 may include a storage device 928, an installation device 916, a network interface 918, an I/O controller 923, display devices 924a-n, a keyboard 926, a pointing device 927, such as a mouse, and one or more other I/O devices 930a-n. The storage device 928 may include, without limitation, an operating system and software. As shown in FIG. 9A, each computing device 900 may also include additional optional elements, such as a memory port 903, a bridge 970, one or more input/output devices 930a-1130n (generally referred to using reference numeral 930), and a cache memory 940 in communication with the central processing unit 921.

The central processing unit 921 is any logic circuitry that responds to and processes instructions fetched from the main memory unit 922. In many embodiments, the central processing unit 921 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. Other examples include SPARC processors, ARM processors, processors used to build UNIX/LINUX “white” boxes, and processors for mobile devices. The computing device 900 may be based on any of these processors, or any other processor capable of operating as described herein.

Main memory unit 922 may be one or more memory chips capable of storing data and allowing any storage location to be directly accessed by the microprocessor 921. The main memory 922 may be based on any available memory chips capable of operating as described herein. In the embodiment shown in FIG. 9A, the processor 921 communicates with main memory 922 via a system bus 950. FIG. 9B depicts an embodiment of a computing device 900 in which the processor communicates directly with main memory 922 via a memory port 903. FIG. 9B also depicts an embodiment in which the main processor 921 communicates directly with cache memory 940 via a secondary bus, sometimes referred to as a backside bus. In other embodiments, the main processor 921 communicates with cache memory 940 using the system bus 950.

In the embodiment shown in FIG. 9A, the processor 921 communicates with various I/0 devices 930 via a local system bus 950. Various buses may be used to connect the central processing unit 921 to any of the I/O devices 930, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 924, the processor 921 may use an Advanced Graphics Port (AGP) to communicate with the display 924. FIG. 9B depicts an embodiment of a computer 900 in which the main processor 921 also communicates directly with an I/O device 930b via, for example, HYPERTRANSPORT, RAPIDIO, or INFINIBAND communications technology.

A wide variety of I/O devices 930a-930n may be present in or connected to the computing device 900, each of which may be of the same or different type as the others. Input devices include keyboards, mice, trackpads, trackballs, microphones, scanners, cameras, and drawing tablets. Output devices include video displays, speakers, inkjet printers, laser printers, and dye-sublimation printers. The I/O devices may be controlled by an I/O controller 923 as shown in FIG. 9A. Furthermore, an I/O device may also provide storage and/or an installation medium 916 for the computing device 900. In some embodiments, the computing device 900 may provide USB connections (not shown) to receive handheld USB storage devices such as the USB Flash Drive line of devices manufactured by Twintech Industry, Inc. of Los Alamitos, Calif.

Referring still to FIG. 9A, the computing device 900 may support any suitable installation device 916, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. In some embodiments, the computing device 900 may provide functionality for installing software over a network. The computing device 900 may further comprise a storage device, such as one or more hard disk drives or redundant arrays of independent disks, for storing an operating system and other software. Alternatively, the computing device 900 may rely on memory chips for storage instead of hard disks.

Furthermore, the computing device 900 may include a network interface 918 to interface to a computer network through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 900 communicates with other computing devices 900′ via any type and/or form of gateway or tunneling protocol such as Secure Socket Layer (SSL) or Transport Layer Security (TLS). The network interface 918 may comprise a built-in network adapter, network interface card, PCMCIA network card, card bus network adapter, wireless network adapter, USB network adapter, modem, or any other device suitable for interfacing the computing device 900 to any type of network capable of communication and performing the operations described herein.

In further embodiments, an I/O device 930 may be a bridge between the system bus 950 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 900 of the sort depicted in FIGS. 9A and 9B typically operates under the control of operating systems, which control scheduling of tasks and access to system resources. The computing device 900 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, WINDOWS 8, WINDOWS VISTA, and WINDOWS 10, all of which are manufactured by Microsoft Corporation of Redmond, WA; MAC OS manufactured by Apple Inc. of Cupertino, Calif.; OS/2 manufactured by International Business Machines of Armonk, N.Y.; Red Hat Enterprise Linux, a Linus-variant operating system distributed by Red Hat, Inc. of Raleigh, N.C.; Ubuntu, a freely-available operating system distributed by Canonical Ltd. of London, England; or any type and/or form of a UNIX operating system, among others.

Having described certain embodiments of methods and systems for modeling and analyzing a physical system comprising a plurality of components, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A computer-implemented method for modeling and analyzing a physical system comprising a plurality of components, the method comprising:
constructing, by a computing device, a model of the plurality of components, wherein the model is based at least in part on at least one parameter relating to a physical characteristic of at least one component;
determining, by the computing device, that the at least one component in the plurality of components represents a region for which at least a first portion of an associated partial differential equation is linear;
accessing, by the computing device, based at least in part on a component type of the at least one component, a dataset from a plurality of datasets, the dataset comprising a representation of the first portion of the partial differential equation, wherein:
the component is an N-dimensional component, N being at least 2,
the component comprises an N-dimensional interior region and an (N−1)-dimensional port,
the dataset comprises a plurality of basis functions for a reduced basis space associated with an interface function for the (N−1)-dimensional port, and
a solution of the first portion of the partial differential equation represented by the accessed dataset depends on at least two independent spatial variables;
determining, by the computing device, that a subset of the plurality of components encapsulates a region for which a second portion of the associated partial differential equation is non-linear;
generating, by the computing device, a combined output based on the partial differential equation combining the first portion and the second portion, wherein a finite element analysis is used in conjunction with the second portion of the associated partial differential equation, the combined output including at least one output value of the at least one component based on at least one input value and wherein the at least one input value is indicative of at least one physical condition under which the physical system is to be evaluated, and the combined output is indicative of a behavior of the physical system under the at least one physical condition.

2. The computer-implemented method of claim 1, wherein the at least one parameter relates to a geometric characteristic of the at least one component.

3. The computer-implemented method of claim 2, wherein a second parameter relates to a non-geometric characteristic of the component.

4. The computer-implemented method of claim 1, wherein the at least one partial differential equation relates to an engineering problem selected from a group consisting of: equilibrium problems, eigenproblems, and time-dependent problems.

5. The computer-implemented method of claim 1, wherein the model includes information relating to a first port of the at least one component for connecting to a second port of a second component of the plurality of components.

6. The computer-implemented method of claim 5 further comprising:
constructing a composite model of the physical system comprising the plurality of components, wherein the act of constructing the composite model comprises using the information relating to the first port to define a relationship between the first model of the first component and a second model of the second component.

7. The computer-implemented method of claim 6, wherein constructing the composite model of the physical system further comprises verifying whether a consistency criterion is satisfied in connecting the first port of the first component to the second port of the second component.

8. The computer-implemented method of claim 6, wherein the physical system comprises a third component having a third port that is not connected to any other component in the physical system, and wherein the composite model of the physical system is constructed based at least in part on one or more boundary conditions for the third port.

9. The computer-implemented method of claim 6, wherein the composite model of the physical system is a first composite model and the at least one output value is at least one first output value, and wherein the method further comprises an act of:
in response to a user request to modify at least one aspect of the physical system, modifying the first composite model to obtain a second composite model of the physical system; and
using the second composite model to compute at least one second output value based at least in part on the at least one input value.

10. The computer-implemented method of claim 9, wherein the user request comprises a request to remove or add a specified component from the physical system.

11. The computer-implemented method of claim 9, wherein the user request comprises a request to change at least one specified parameter of a specified component.

12. The computer-implemented method of claim 9, wherein the user request comprises a request to disconnect two specified ports.

13. The computer-implemented method of claim 9, wherein at least one aspect of the physical system is a first aspect of the physical system, and wherein the method further comprises acts of:
determining whether a consistency criterion is violated due to modifying the first aspect of the physical system as requested; and
if it is determined that a consistency criterion is violated due to modifying the first aspect of the physical system as requested, modifying at least one second aspect of the physical system so that the consistency criterion is no longer violated.

14. The computer-implemented method of claim 1, wherein the method further comprises visually rendering the at least one output value.

15. The computer-implemented method of claim 14, wherein the at least one output value comprises a plurality of output values over a three-dimensional (3D) domain, and wherein the method further comprises visually rendering the plurality of output values over the 3D domain.

16. The computer-implemented method of claim 1, wherein the component is a first component, the model of the first component is a first model, and the physical system further comprises a second component that is identical to the first component, and wherein the method further comprises constructing a second model of the second component based at least in part on the first model.

17. The computer-implemented method of claim 1, wherein the accessed dataset further comprises data generated by solving a plurality of instances of the at least one partial differential equation, each instance corresponding to a different set of one or more parameters for the at least one partial differential equation.

18. The computer-implemented method of claim 1, wherein the component is a first component, the model of the first component is a first model, and the physical system further comprises a second component, and wherein the method further comprises:
receiving a user request to clone a subsystem of the physical system, the user request identifying the first and second components as being in the subsystem to be cloned;
constructing a third model of a third component based at least in part on the first model;
constructing a fourth model of a fourth component based at least in part on a second model of the second component; and
using the first, second, third, and fourth models to construct a composite model of the physical system.

19. A system for modeling and analyzing a physical system comprising a plurality of components, the system comprising:
at least one processor programmed to:
construct a model of the plurality of components, wherein the model is based at least in part on at least one parameter relating to a physical characteristic of at least one component;
determine that the at least one component in the plurality of components represents a region for which at least a first portion of an associated partial differential equation is linear;
access based at least in part on a component type of the at least one component, a dataset from a plurality of datasets, the dataset comprising a representation of the first portion of the partial differential equation, wherein:
the component is an N-dimensional component, N being at least 2,
the component comprises an N-dimensional interior region and an (N−1)-dimensional port,
the dataset comprises a plurality of basis functions for a reduced basis space associated with an interface function for the (N−1)-dimensional port, and
a solution of the first portion of the partial differential equation represented by the accessed dataset depends on at least two independent spatial variables;
determine that a subset of the plurality of components encapsulates a region for which a second portion of the associated partial differential equation is non-linear;
generate a combined output based on the partial differential equation combining the first portion and the second portion, wherein a finite element analysis is used in conjunction with the second portion of the associated partial differential equation, the combined output including at least one output value of the at least one component based on at least one input value and wherein the at least one input value is indicative of at least one physical condition under which the physical system is to be evaluated, and the combined output is indicative of a behavior of the physical system under the at least one physical condition.

20. At least one non-transitory computer-readable medium having encoded thereon instructions that, when executed by at least one processor on a computing device, implement a method for modeling and analyzing a physical system comprising a plurality of components, the method comprising the steps of:
constructing, by the computing device, a model of the plurality of components, wherein the model is based at least in part on at least one parameter relating to a physical characteristic of at least one component;
determining, by the computing device, that the at least one component in the plurality of components represents a region for which at least a first portion of an associated partial differential equation is linear;
accessing, by the computing device, based at least in part on a component type of the at least one component, a dataset from a plurality of datasets, the dataset comprising a representation of the first portion of the partial differential equation, wherein:
the component is an N-dimensional component, N being at least 2,
the component comprises an N-dimensional interior region and an (N−1)-dimensional port,
the dataset comprises a plurality of basis functions for a reduced basis space associated with an interface function for the (N−1)-dimensional port, and
a solution of the first portion of the partial differential equation represented by the accessed dataset depends on at least two independent spatial variables;
determining, by the computing device, that a subset of the plurality of components encapsulates a region for which a second portion of the associated partial differential equation is non-linear;
generating, by the computing device, a combined output based on the partial differential equation combining the first portion and the second portion, wherein a finite element analysis is used in conjunction with the second portion of the associated partial differential equation, the combined output including at least one output value of the at least one component based on at least one input value and wherein the at least one input value is indicative of at least one physical condition under which the physical system is to be evaluated, and the combined output is indicative of a behavior of the physical system under the at least one physical condition.
